(19) United States
(12) Patent Application Publication
(10) Pub. No.: US 2026/0313557 A1
(43) Pub. Date: Oct. 8, 2026

(54) DYNAMIC POWER MANAGEMENT OF ETHERNET INTERFACE

(71) Applicant: Cisco Technology, Inc., San Jose, CA (US)

(72) Inventors: Aviran Kadosh, Moreshet (IL); Iddo Peled, TEL AVIV-YAFO (IL); Naor Goldman, caesarea (IL); Liron Sheffer, CAESAREA (IL)

(21) Appl. No.: 19/172,639

(22) Filed: Apr. 7, 2025

(51) Int. Cl. H04W 52/02

(52) U.S. Cl. CPC H04W 52/0251

(57) ABSTRACT

Systems, devices, and methods dynamically manage power of an Ethernet interface. A transmitting network device (TND) determines absence of pending data for processing, based on which the TND completes transmission of residual processed data of an ongoing data transfer operation. The TND transmits one or more control indications to a Serializer/Deserializer (SerDes) transmitter of a SerDes system based on the completion of the transmission of the residual processed data. The SerDes transmitter transitions from a power-up mode to a power-down mode based on the control indication(s). The TND determines presence of the pending data, based on which the TND transmits another control indication(s) to the SerDes transmitter. The SerDes transmitter transitions from the power-down mode to the power-up mode based on the other control indication(s). The SerDes system terminates transmission or reception of the data, and recovers without any influence on a link or the data.

The present disclosure relates to power management. More particularly, the present disclosure relates to dynamically managing power of an Ethernet interface.

### BACKGROUND

With the exponential advancement of digital technologies and increasing dependence on networks, network devices including, for example, switches, routers, access points, servers, or the like, continue to grow in number, performance, and usage, resulting in increased power consumption. In high-performance network devices such as switches and routers, excessive power consumption may lead to higher temperatures, which can affect the reliability and longevity of hardware. Efficient power use may improve the feasibility to deploy large numbers of network devices without overwhelming power infrastructure, while also making it easier to scale the networks without excessive energy costs. Further, reducing power consumption may help decrease the carbon footprint of network operations, contributing to sustainability goals.

In network devices such as switches and routers, about 25%-40% of power may be consumed by an integrated Serializer/Deserializer (SerDes), about 30%-40% of power may be consumed by data processing, about 30%-40% of power may be consumed as idle power, and about 2%-5% of power may constitute leakage. A SerDes, typically utilized for high-speed communication applications, may include an electronic circuit that transforms parallel data into serial data and vice versa. The SerDes may operate or stay powered-up continuously, even when not actively transmitting or receiving data because a phase-locked loop acquisition time in a receiver may be too long if the SerDes starts up from a completely powered-down mode. Idle power, which may include power consumed when there is no network traffic, may be substantially high. A clock distribution network, referred to as a “clock tree,” and lower layers of an Ethernet interface, may typically consume the idle power. While higher layers of the Ethernet interface may utilize clock gating techniques for reducing power consumption when there is no network traffic, the lower layers may continue to process incoming idle data patterns and to consume power. There is a need for minimizing idle power and power consumed by the Ethernet interface when no data is being transmitted to potentially save device power consumption and lower overall energy costs.

### SUMMARY OF THE DISCLOSURE

Systems, devices, and methods for dynamically managing power of an Ethernet interface in accordance with embodiments of the disclosure are described herein. In many embodiments, a transmitting network device comprises a Serializer/Deserializer (SerDes) transmitter, one or more processors, a memory communicatively coupled to the one or more processors, and a power management logic. The SerDes transmitter is operable in a power-up mode or a power-down mode. The power management logic is configured to determine an absence of pending data for processing; complete transmission of residual processed data of an ongoing data transfer operation based on the determined absence of the pending data for the processing; and transmit one or more control indications to the SerDes transmitter based on the completion of the transmission of the residual processed data. The SerDes transmitter is configured to transition from the power-up mode to the power-down mode based on the one or more control indications.

In a number of embodiments, the transmitting network device further comprises a data buffer configured to store the pending data for the processing.

In a variety of embodiments, the determination of the absence of the pending data is based on the data buffer being empty.

In various embodiments, the determination of the absence of the pending data is based on the data buffer being empty for a configured time period.

In more embodiments, the transmitting network device further comprises a data pipeline, operably coupled to the data buffer, that is configured to provide the residual processed data of the ongoing data transfer operation to the SerDes transmitter for the transmission.

In additional embodiments, based on the determined absence of the pending data, the power management logic is further configured to terminate a transmission of one or more idle data patterns to the SerDes transmitter.

In further embodiments, at least one control indication of the one or more control indications comprises an indication of a last transaction including a last bit of the residual processed data.

In still more embodiments, at least one control indication of the one or more control indications comprises a power-transition signal configured to trigger the transition of the SerDes transmitter from the power-up mode to the power-down mode.

In still further embodiments, the power management logic is further configured to determine a presence of the pending data for the processing; and transmit another one or more control indications to the SerDes transmitter based on the determined presence of the pending data for the processing.

In still additional embodiments, the SerDes transmitter is further configured to transition from the power-down mode to the power-up mode based on the another one or more control indications.

In some more embodiments, at least one control indication of the another one or more control indications comprises a power-transition signal configured to trigger the transition of the SerDes transmitter from the power-down mode to the power-up mode.

In yet various embodiments, based on the transition of the SerDes transmitter to the power-up mode, the power management logic is further configured to receive feedback from the SerDes transmitter regarding readiness to receive the pending data.

In yet more embodiments, at least one control indication of the another one or more control indications comprises an indication of a valid transaction configured to trigger the transmission of the pending data to the SerDes transmitter.

In still yet more embodiments, the SerDes transmitter is further configured to transmit the pending data from a parallel data bus to a serial data line.

In many further embodiments, the transmitting network device further comprises a Media Access Control (MAC) transmitter configured to provide the residual processed data of the ongoing data transfer operation to the SerDes transmitter for the transmission.

In many additional embodiments, the power management logic is configured in the MAC transmitter.

In still yet further embodiments, a receiving network device comprises a SerDes receiver configured to receive data from a transmitting network device; a MAC receiver coupled to the SerDes receiver; and a power management logic configured to: determine that the received data corresponds to one of a last valid transaction or a first valid transaction; and transmit one or more control indications to the MAC receiver based on the received data corresponding to the one of the last valid transaction or the first valid transaction, wherein, based on the one or more control indications, the MAC receiver is configured to transition from a first power mode to a second power mode.

In still yet additional embodiments, based on the received data corresponding to the first valid transaction: the one or more control indications comprises a first valid signal configured to trigger the transition of the MAC receiver, the first valid signal comprises a first valid bit index associated with the received data, and the transition from the first power mode to the second power mode comprises a transition from a power-down mode to a power-up mode.

In several embodiments, based on the received data corresponding to the first valid transaction: the one or more control indications comprises a power-transition signal configured to trigger the transition of the MAC receiver, and the transition from the first power mode to the second power mode comprises a transition from a power-down mode to a power-up mode.

In several more embodiments, based on the received data corresponding to the last valid transaction: the one or more control indications comprises a last valid signal configured to trigger the transition of the MAC receiver, the last valid signal comprises a last valid bit index associated with the received data, and the transition from the first power mode to the second power mode comprises a transition from a power-up mode to a power-down mode.

In numerous embodiments, based on the received data corresponding to the last valid transaction: the one or more control indications comprises a power-transition signal configured to trigger the transition of the MAC receiver, and the transition from the first power mode to the second power mode comprises a transition from a power-up mode to a power-down mode.

In numerous additional embodiments, the received data from the transmitting network device is free of one or more idle data patterns.

In further additional embodiments, a method comprises determining absence of pending data for processing; completing transmission of residual processed data of an ongoing data transfer operation based on the determined absence of the pending data for the processing; and transmitting one or more control indications to a SerDes transmitter based on the completion of the transmission of the residual processed data. The SerDes transmitter is configured to transition from a power-up mode to a power-down mode based on the one or more control indications.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently disclosed embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a communication layer architecture in accordance with various embodiments of the disclosure;

FIG. 2 is a block diagram of a system for dynamically managing power of an Ethernet interface in accordance with various embodiments of the disclosure;

FIG. 3 is a schematic diagram illustrating a finite state machine associated with dynamic power management of an Ethernet interface in accordance with various embodiments of the disclosure;

FIG. 4 is a flowchart depicting a process for dynamically managing power of an Ethernet interface associated with transmission of data in accordance with various embodiments of the disclosure;

FIG. 5 is a flowchart depicting a process for dynamically managing power of an Ethernet interface through power mode transitions in accordance with various embodiments of the disclosure;

FIG. 6 is a flowchart depicting a process for dynamically managing power of an Ethernet interface associated with reception of data in accordance with various embodiments of the disclosure;

FIG. 7 is a flowchart depicting a process for dynamically managing power of an Ethernet interface associated with reception of data corresponding to a last valid transaction in accordance with various embodiments of the disclosure;

FIG. 8 is a flowchart depicting a process for dynamically managing power of an Ethernet interface associated with reception of data corresponding to a first valid transaction in accordance with various embodiments of the disclosure;

FIG. 9 is a flowchart depicting a process for dynamically managing power of an Ethernet interface to resolve a device failure in accordance with various embodiments of the disclosure; and

FIG. 10 is a conceptual block diagram of a device suitable for configuration with the power management logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for dynamically managing power of an Ethernet interface. Ethernet may refer to a communication standard, for example, the Institute of Electrical and Electronics Engineers (IEEE) 802.3 standard, based on an access control mechanism such as a Carrier Sense Multiple Access/Collision Detection (CSMA/CD) protocol, utilized for connecting network devices in a wired Local Area Network (LAN) or a Wide Area Network (WAN) and for transmitting data over both wired and wireless network connections. The Ethernet may operate at a data link layer of an Open Systems Interconnection (OSI) model, with some elements operating at a physical (PHY) layer. The Ethernet interface may refer to a network interface that allows a network device to connect and communicate with other network devices over an Ethernet network. The Ethernet interface may allow the network device to transmit and receive data over the Ethernet network using Ethernet protocols. The Ethernet interface may include, for example, a physical interface or a port for plugging an Ethernet cable, a hardware component such as a Network Interface Controller (NIC), and a Media Access Control (MAC) address configured to direct the data to a target network device.

The Ethernet interface implemented, for example, with high-speed Ethernet standards such as 1 Gigabit (1G) Ethernet, 10G Ethernet, 40G Ethernet, 100G Ethernet, or the like, may incorporate a Serializer/Deserializer (SerDes) system. The SerDes system may include a SerDes transmitter at a transmitter side of the Ethernet interface, and a SerDes receiver at a receiver side of the Ethernet interface. The SerDes system may convert parallel data streams from an Ethernet MAC layer into serial data, at the transmitter side, for transmission over a physical medium, and may convert the serial data into parallel data at the receiver side. The physical medium may include, for example, copper cables, fiber optic cables, or the like. The SerDes system may be embedded, for example, in an Ethernet PHY layer chip, configured for electrical and physical transmission of data over the physical medium. The SerDes system may allow high-speed data transmission over long distances by optimally packing and unpacking the data. The Ethernet MAC layer may frame, address, and perform error checking of the data. Further, the Ethernet MAC layer may transmit the data, for example, as Ethernet frames in a parallel form, herein referred to as “parallel data,” to the SerDes system for serialization. The SerDes transmitter may be configured to perform serialization. The SerDes receiver may be configured to perform deserialization. The SerDes transmitter may receive the parallel data from the Ethernet MAC layer, convert the received parallel data into a serial data stream, and transmit the serial data stream to the SerDes receiver. The SerDes receiver may receive and reconstruct the incoming serial data stream back into parallel data that the Ethernet MAC layer can process. The SerDes receiver may transmit the reconstructed parallel data to the Ethernet MAC layer for further processing including, for example, error checking by utilizing a Cyclic Redundancy Check (CRC), de-framing, and forwarding the reconstructed parallel data to higher layers in a networking stack. The SerDes receiver may include a Clock Data Recovery (CDR) mechanism that extracts a clock signal from the incoming serial data stream for synchronizing the data.

In network devices such as switches and routers, about 25%-40% of power may be consumed by an integrated SerDes system. The SerDes system may operate or stay powered-up continuously, even when not actively transmitting or receiving the data because a Phase-Locked Loop (PLL) acquisition time in the SerDes receiver may be too long if the SerDes system starts up from a completely powered-down mode. Continuously operating in the powered-up mode, even when there is no network traffic, may increase power consumption. While higher layers of the Ethernet interface may utilize clock gating techniques for reducing power consumption when there is no network traffic, the lower layers may continue to process incoming idle data patterns and to consume power. There is a need for minimizing idle power and power consumed by the Ethernet interface when no data is being transmitted to potentially reduce device power consumption and lower overall energy costs.

Modern electronic systems, for example, in telecommunication networks, data centers, or networked devices, may need to balance performance with power consumption. Dynamic power management may allow these electronic systems to only consume power when necessary, avoiding unnecessary energy use. By transmitting the state knowledge of a power status of these electronic systems, for example, power modes, active states, idle states, or the like, components of these electronic systems can make intelligent decisions to enter low-power modes, also referred to as “power-down” modes, or shutdown idle components when they are not needed, thereby reducing the overall power consumption and improving energy efficiency of these electronic systems. Power-down mode may refer to a state or operation mode of a device, a circuit, or a system where its power consumption is reduced to extend battery life, minimize energy use, or decrease heat generation, for example, when full functionality is not required or when the system is idle. In large-scale electronic systems, multiple components such as processors, transceivers, memory modules, network interfaces, or the like may have varying power requirements. Transmitting the state knowledge of the power status may allow these components to coordinate power usage. For example, if one component enters a power-down mode, other components can adapt their operation accordingly. However, as additional modes, such as the power-down mode is implemented into SerDes processes, additional granularity that tracks specific messages or events useful for specific SerDes applications can become harder to achieve. Further, as the SerDes system may be utilized for high-speed data transmission, achieving low-power operation in high-performance electronic systems can be challenging, but required for reducing power consumption in network devices.

Before transmission of a data stream occurs, both ends of a communication link may establish a physical connection. A link establishment process may begin with the SerDes transmitter transmitting a link training sequence, for example, a specific signal pattern, to allow the SerDes receiver to detect the signal pattern and properly synchronize its PLL to recover a clock signal embedded in the data stream. This clock recovery may ensure that the SerDes receiver is properly synchronized with a data rate of the SerDes transmitter. Since the SerDes transmitter may transmit the data serially, that is, one bit at a time, the clock signal may be utilized to define when each bit should be read or sampled from the data stream. The SerDes receiver may utilize the clock signal to sample the data stream at the right time. If applicable, the SerDes receiver and the SerDes transmitter may implement an auto-negotiation process including an exchange of information to agree on connection parameters such as data rate, for example, 10 megabits per second (Mbps), 100 Mbps, 1 Gbps, or the like, and a duplex mode, for example, a full-duplex mode or a half-duplex mode. This auto-negotiation process may include transmission of control frames by the MAC layer to facilitate finalization of the connection parameters.

At link startup, the data transmitted by the SerDes transmitter on a serial data line to the SerDes receiver may be lost. During the link establishment, there is no significant data passing between a transmitter including the SerDes transmitter and a receiver including the SerDes receiver of the Ethernet interface. However, data must always be available on a parallel data bus of the transmitter, as the SerDes transmitter cannot stop transmitting data. The SerDes transmitter cannot stop transmitting the data because the CDR mechanism of the SerDes receiver must receive network traffic transactions for its basic operation, for clock recovery, and to remain locked. If a MAC transmitter at the transmitter side does not have data in a transmitter data buffer, the MAC transmitter may generate idle data patterns for transmission by the SerDes transmitter to allow the SerDes transmitter to keep transmitting data. The SerDes receiver may receive one transaction from the parallel data bus of the transmitter per clock signal of the transmitter. The SerDes receiver may always receive the data from the SerDes transmitter via the serial data line and transmit the data on a parallel data bus of the receiver to the MAC receiver. The MAC receiver may receive one transaction from the parallel data bus of the receiver per clock signal of the receiver. The offset between the data on the parallel data bus of the transmitter and the data on the parallel data bus of the receiver may be random, as there are no control signals to indicate a start of the data and an end of the data on the serial data line. The MAC receiver may perform offset shifting, reconstruct the original data pattern, filter out all the idle data patterns, and transmit the data to a receiver data buffer. Most often, a maximum capacity or a port rate of the serial data line may not be fully utilized, due to which a high percentage of the transmitted data may include idle data patterns, that are dropped on the receiver side, causing a wastage of energy.

The present disclosure addresses the above-mentioned challenges by providing systems, devices, and methods for dynamically managing power of an Ethernet interface. In many embodiments, the systems, devices, and methods discussed herein may provide a power management logic configured to transmit state knowledge about various aspects of a power status of components of an electronic system, for example, a signaling system, to other components of the electronic system, thereby facilitating optimal responses and reactive decision-making therewithin. By transmitting the state knowledge of the power status, the components of the electronic system can make intelligent decisions to enter the power-down modes or shutdown idle components when they are not needed, thereby reducing the overall power consumption and improving energy efficiency of the electronic system. In a number of embodiments, the power management logic may operate as a conservative SerDes interface where no additional data is added or lost, when components of the electronic system enter or exit the power-down mode. The conservative SerDes interface may refer to an implementation of the SerDes interface that prioritizes reliable data transmission, robust performance, and minimal risk of errors. In a variety of embodiments, the power management logic is configured in the MAC transmitter, which may determine when the SerDes transmitter may enter or exit the power-down mode. In various embodiments, the power management logic may reduce power consumption by avoiding or terminating transmission of idle data patterns for extended time periods of idle links and powering down all relevant circuits. In more embodiments, the power management logic may terminate transmission or reception of data and recover without any influence on the links or the data.

The systems, devices, and methods discussed herein may dynamically manage power of an Ethernet interface through power mode transitions. In additional embodiments, the power management logic may determine an absence of pending data for processing, complete transmission of residual processed data of an ongoing data transfer operation based on the determined absence of the pending data for the processing; and transmit one or more control indications to the SerDes transmitter based on the completion of the transmission of the residual processed data. The control indication may include, for example, an indication of a last transaction including a last bit of the residual processed data, a power-transition signal configured to trigger the transition of the SerDes transmitter from a power-up mode to the power-down mode, an indication of a valid transaction configured to trigger the transmission of the pending data to the SerDes transmitter, or the like. The SerDes transmitter may transition from the power-up mode to the power-down mode based on the control indication(s).

The power management logic may provide an additional level of granularity for augmenting the SerDes system. For example, an additional bit may be configured to indicate whether the last valid bit has been received prior to a portion of the SerDes system entering the power-down mode. By utilizing an increased granularity, for example, by transmitting control indications such as power-transition signals, first valid transactions, last valid transactions, completion of transmission of residual processed data, or the like, to the SerDes transmitter, the system disclosed herein can transmit state knowledge about various aspects of its power status to other components of the system, thereby facilitating optimal responses and reactive decision-making therewithin. In further embodiments, the control indications may be configured to transmit the state knowledge of the power status and provide an additional granularity required to track specific messages and events useful for specific SerDes applications, for example, accessing external memories with a high-speed SerDes interface, handling invalid read/write accesses or parallel data writes, or the like. In still more embodiments, the control indications may be configured to trigger an external memory to enter a power-down mode. In still further embodiments, the SerDes system may operate in the power-down mode, conserving energy when full performance is not required while maintaining the ability to quickly return to a full-speed operation when needed. Transmitting the state knowledge about the power status of various components may optimize power consumption, improve system performance, ensure reliability, and enable thermal and resource management. Further, the transmission of the state knowledge may allow the system to dynamically adapt to changing conditions, ultimately contributing to energy conservation, system longevity, and cost reduction in large-scale, high-performance environments. By sharing the state knowledge of the power status, the system may execute intelligent actions to reduce energy waste, enhance operational efficiency, and maintain overall system health.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In further additional embodiments, a circuit may include a return pathway for electric current, so that the circuit is a closed loop. In many embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In a number of embodiments, a circuit may include a portion of an integrated circuit, an integrated circuit, a set of integrated circuits, a set of non-integrated electrical and/or electrical components with or without integrated circuit devices, or the like. In a variety of embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

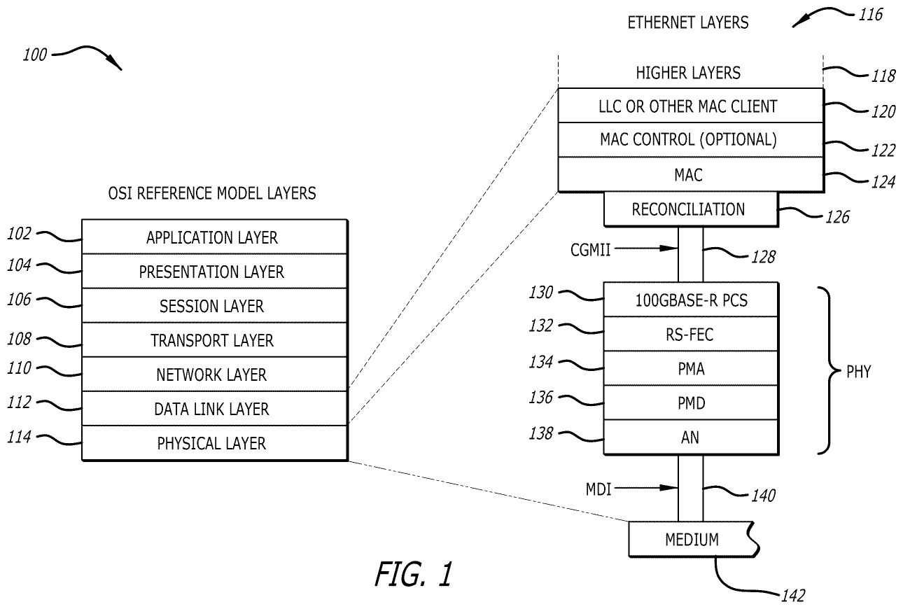

Referring to FIG. 1, a schematic diagram of a communication layer architecture 100 in accordance with various embodiments of the disclosure is shown. In many embodiments, the communication layer architecture 100 may be utilized to carry out various communications described or required herein. In a number of embodiments, the communication layer architecture 100 may be configured as an Open Systems Interconnection (OSI) model. In a variety of embodiments, the communication layer architecture 100 may include seven layers which may be implemented in accordance with the OSI model. The seven layers include, for example, a physical layer 114, a data link layer 112, a network layer 110, a transport layer 108, a session layer 106, a presentation layer 104, and an application layer 102.

In various embodiments, the physical layer 114 may serve as a foundational layer among the seven layers. The physical layer 114 may represent the first layer of the OSI model and may be referred to as “layer 1”. The physical layer 114 may be responsible for an actual physical connection between devices and transmission and reception of raw, unstructured data over a physical medium (denoted as “medium 142”) including, for example, cables such as twisted pair cables, fiber optic cables, or the like, or wireless connections. The physical layer 114 may include physical equipment involved in a data transfer and electrical/optical, mechanical, and functional interfaces to the physical medium. The physical layer 114 may carry signals for the higher layers of the OSI model. The physical layer 114 may provide synchronization of bits through a clock, define a transmission rate, that is, the number of bits transmitted per second, define an arrangement of different devices in a network, and define how the data flows between the two connected devices. The devices operating at the physical layer 114 may include network cables such as Ethernet cables, fiber optic cables, or the like, connectors, repeaters, hubs, or the like.

In more embodiments, the data link layer 112 may provide an error-free transfer of data frames from one device to another over the physical layer 114, allowing the layers 102-110 above the data link layer 112 to assume a substantially error-free transmission over a link. The data link layer 112 may represent the second layer of the OSI model and may be referred to as “layer 2”. The data link layer 112 may be configured to perform framing, error detection and correction, flow control, access control, and addressing. An example of a protocol utilized in the data link layer 112 may be Ethernet. Ethernet may operate in the physical layer 114 and the data link layer 112 of the OSI model. The data link layer 112 may be divided into two sublayers: a Logical Link Control (LLC) sublayer 120 and a Media Access Control (MAC) sublayer 124. The LLC sublayer 120 may manage communication between devices on the network and handle error correction, flow control, and data link management. The LLC sublayer 120 may be responsible for identifying and encapsulating higher-layer protocols such as an Internet Protocol (IP). The MAC sublayer 124 may control how the devices access the physical medium and transmit data. The MAC sublayer 124 may handle the addressing of the devices using MAC addresses, access control methods, and how to handle the data frames when they are ready for transmission. The devices that operate at the data link layer may include, for example, Network Interface Cards (NICs), switches, bridges, or the like. The data link layer may facilitate creation of a reliable point-to-point or point-to-multipoint link for data transmission between neighboring devices.

In additional embodiments, the network layer 110 may control the operation of a subnet, determining which physical path the data should take based on network conditions, priority of service, and other factors. The network layer 110 may represent the third layer of the OSI model and may be referred to as “layer 3”. The network layer 110 may perform logical addressing, routing, and the fragmentation and reassembly of data packets. In further embodiments, the network layer 110 may ensure that the data is directed from a source to a destination, even when the devices are not directly connected. An example of a protocol utilized in the network layer 110 may be IP. The devices that operate at the network layer 110 may include, for example, routers, for routing data between different networks or subnets. The network layer 110 may determine an optimal path for data to traverse through a network based on logical addressing. The network layer 110 may abstract the underlying physical layer 114 and the data link layer 112, allowing for a more scalable and flexible communication infrastructure.

In still more embodiments, the transport layer 108 facilitates delivery of error-free messages, in sequence, and with no losses or duplications. The transport layer 108 may represent the fourth layer of the OSI model and may be referred to as “layer 4”. The transport layer 108 may be responsible for end-to-end communication between two devices. The transport layer 108 may also provide an acknowledgment of a successful data transmission and re-transmit data if an error is found. The transport layer 108 may segment and reassemble the data for transmission between the devices, perform error detection and correction, ensure flow control, and manage data transmission rates. Examples of protocols utilized in the transport layer 108 may include a Transmission Control Protocol (TCP), User Datagram Protocol (UDP), Point-to-Point Tunneling Protocol (PPTP), or the like.

In still further embodiments, the session layer 106 may be responsible for the establishment of connections, management of connections, and terminations of sessions between two devices. The session layer 106 may facilitate session establishment between processes running on different devices. The session layer 106 may represent the fifth layer of the OSI model and may be referred to as “layer 5”. The session layer 106 may synchronize data exchange, allowing for full-duplex, half-duplex, or simplex communication. The session layer 106 may allow a process to add checkpoints that are considered synchronization points in the data. These synchronization points may assist in identifying an error to allow a proper resynchronization of the data, to preclude ends of messages from being cut prematurely, and to avoid data loss. The session layer 106 may manage the sessions between two communicating devices, ensuring that data flows in the correct order.

In still additional embodiments, the presentation layer 104 may format the data for presentation to the application layer 102. The presentation layer 104 may represent the sixth layer of the OSI model and may be referred to as “layer 6”. The presentation layer 104 may be responsible for translation, encryption, and compression of data between the application layer 102 and the transport layer 108. The presentation layer 104 may be viewed as a translator for the network. The presentation layer 104 may translate data from a format utilized by the application layer 102 into a common format at a transmitting device and then translate the common format to a format known by the application layer 102 at a receiving device.

In some more embodiments, the application layer 102 may serve as a window for users and application processes to access network services and for displaying received information to the users. The application layer 102 may represent the seventh layer of the OSI model and may be referred to as “layer 7”. The application layer 102 may be implemented by network applications that generate the data to be transmitted over the network. Examples of protocols utilized in the application layer 102 may include a HyperText Transfer Protocol (HTTP), Simple Mail Transfer Protocol (SMTP), File Transfer Protocol (FTP), Domain Name System (DNS), or the like. The application layer 102 may directly interact with end-user applications. The application layer 102 may provide network services to the applications and facilitate user interaction with the network. In yet various embodiments, the application layer 102 may operate as a mediator, allowing different software applications to communicate seamlessly across the network.

Further, the Ethernet interface may be defined by the Institute of Electrical and Electronics Engineers (IEEE) as layers of functions as illustrated in FIG. 1, as captured from the IEEE802.3cx standard. The embodiments illustrated in FIG. 1 are described in the context of Ethernet layers 116 including, for example, a reconciliation layer 126, a MAC sublayer 124, an optional MAC control layer 122, an LLC sublayer 120, and higher layers 118. The optional MAC control layer 122, the LLC sublayer 120, and the higher layers 118 may be referred to as “upper layers 118-122.” The reconciliation layer 126, the MAC sublayer 124, and the upper layers 118-122 may process incoming and outgoing packets and may not operate when the link is idle, and no packets are transmitted or received. In lower layers that are below the reconciliation layer 126, the MAC sublayer 124, and the upper layers 118-122, the packets may be converted into a continuous stream of bits. These bits may be scrambled to guarantee frequent bit transitions from zero to one and vice versa. The continuous scrambled bits may imply that the lower layers are never idle. The lower layers may process the stream of bits even when they do not carry real network traffic.

In yet more embodiments, the reconciliation layer 126 may communicate with the Ethernet PHY layer via a Common Gigabit Media Independent Interface (CGMII) 128. The Ethernet PHY layer may represent a physical layer device. In still yet more embodiments, the CGMII 128 may operate at speeds, for example, up to 1000 Mbps, implemented using a data interface clocked at 125 megahertz (MHz) with separate eight-bit data paths for receive and transmit. In many further embodiments, the CGMII 128 may support 100 Gbps operation through its 64-bit-wide transmit and receive data paths. The Ethernet PHY layer may include 100GBASE-R Physical Coding Sublayer (PCS) 130, Reed Solomon-Forward Error Correction (RS-FEC) 132, a Physical Medium Attachment (PMA) 134, and a Physical Medium Dependent (PMD) sublayer 136. 100GBASE-R may represent a group or family of physical layer devices, for example, 100 Gbps transceivers, where “BASE” may refer to a baseband transmission method in which the entire bandwidth of the medium 142 may be utilized to transmit a single data stream. The 100GBASE-R PCS 130 may be responsible for encoding and decoding data to be transmitted over the medium 142. The RS-FEC 132 may refer to a RS-FEC codeword-interleaved sublayer that may be utilized for error correction during the transmission of the data. In many additional embodiments, the Ethernet PHY layer may include the RS-FEC 132 based on the type of physical layer device. The PMA 134 may refer to a sublayer of the Ethernet PHY layer responsible for providing an interface between the Ethernet PHY layer and the medium 142. The PMA 134 may refer to a sublayer of the Ethernet PHY layer responsible for ensuring that the data is properly encoded or decoded for transmission over the medium 142. The PMA 134 may operate directly with the PMD sublayer 136 to transmit and receive the data, for example, across cables or optical fibers. The PMD sublayer 136 may define the electrical, optical, or radio signals utilize for transmission, and specifications for physical connectors. The PMD sublayer 136 may define characteristics and properties, for example, signal levels, encoding schemes, or the like, of the medium 142, and how the transmission and reception of the data interact with this medium 142.

In still yet further embodiments, the Ethernet PHY layer may implement an Auto-Negotiation (AN) protocol 138 based on the type of physical layer device. The AN protocol 138 may allow the devices on the network to automatically detect and agree on the best possible communication parameters such as speed and duplex mode based on the capabilities of both the devices. The AN protocol 138 may operate at the physical layer 114 to ensure that both the devices on the link can automatically agree on an optimal configuration for communication. The Ethernet PHY layer may communicate with the medium 142 via a Medium Dependent Interface (MDI) 140. The MDI 140 may define how a device physically connects to the medium 142 via the Ethernet interface and how signals are transmitted over that medium 142. The MDI 140 may specify whether the device is connected, for example, to an MDI-X (crossed wiring for a direct connection) or MDI (non-crossed, direct-to-device) interface.

In still yet additional embodiments, the systems, devices, and methods discussed herein dynamically manage power of the Ethernet interface described in the context of Ethernet layers 116 illustrated in FIG. 1. In several embodiments, while the upper layers 118-122 may utilize clock gating techniques for reducing power consumption whenever there is no network traffic, the lower layers may continue to process incoming idle data patterns and consume power. The systems, devices, and methods discussed herein may provide a power management logic configured to power down the PMD sublayer 136 and the upper layers including, for example, the PMA 134, the RS-FEC 132, the 100GBASE-R PCS 130, the reconciliation layer 126, the MAC sublayer 124, and the upper layers 118-122. In several more embodiments, the power management logic may be configured to transmit state knowledge about various aspects of a power status of components of an electronic system, for example, a signaling system, to other components of the electronic system, thereby facilitating optimal responses and reactive decision-making therewithin. By transmitting the state knowledge of the power status, the components of the electronic system can make intelligent decisions to enter the power-down modes or shutdown idle components when they are not needed, thereby reducing the overall power consumption and improving energy efficiency of the electronic system. The systems, devices, and methods discussed herein may dynamically manage power of the Ethernet interface through power mode transitions.

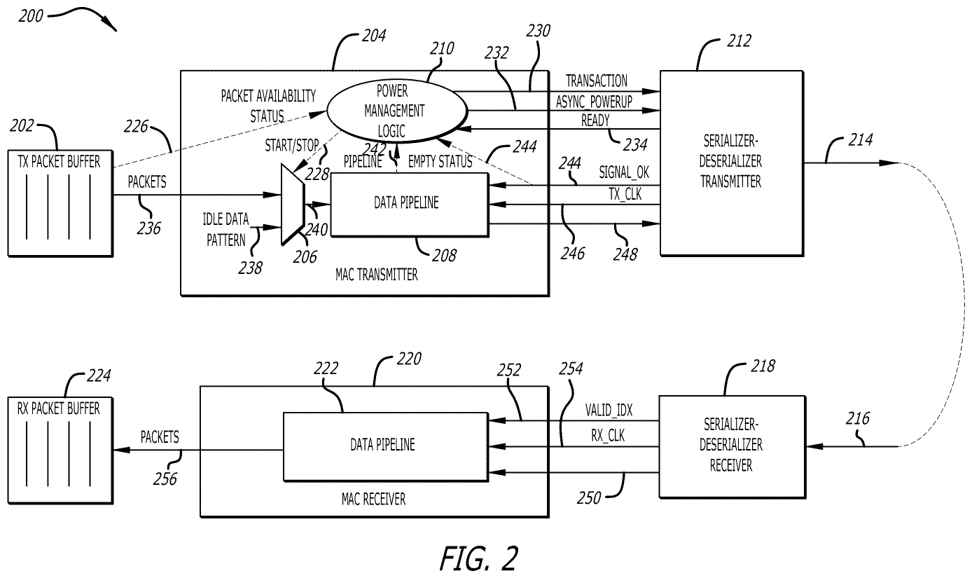

Although a specific embodiment for a communication layer architecture 100 suitable for carrying out the various steps, processes, methods, and operations described herein is discussed with respect to FIG. 1, any of a variety of systems and/or processes may be utilized in accordance with embodiments of the disclosure. For example, various aspects described herein may reside or be carried out on one layer or a plurality of layers of the communication layer architecture 100. The elements depicted in FIG. 1 may also be interchangeable with other elements of FIG. 2-10 as required to realize a particularly desired embodiment.

Referring to FIG. 2, a block diagram of a system 200 for dynamically managing power of an Ethernet interface in accordance with various embodiments of the disclosure is shown. In many embodiments, the system 200 illustrated in FIG. 2 may be configured for transmission and reception of data over Ethernet and may represent an exemplary implementation of the Ethernet interface. In a number of embodiments, the system 200 may implement a Serializer/Deserializer (SerDes) system including a SerDes transmitter 212 and a SerDes receiver 218. The SerDes transmitter 212 may be communicatively coupled to the SerDes receiver 218 via their respective serial data lines 214 and 216. The SerDes transmitter 212 and the SerDes receiver 218 may be operable in a power-up mode or a power-down mode. The power-up mode may refer to an operational state that a component of the system 200 enters when the component is powered on and initialized for normal data communication including data transmission and data reception. In the power-up mode, the SerDes transmitter 212 may be ready to serialize data from a parallel format of multiple bits to a high-speed serial data stream and transmit the high-speed serial data stream over a communication link. Further, in the power-up mode, the SerDes receiver 218 may be powered on, initialized, and ready to receive, detect, synchronize, decode, and deserialize the high-speed serial data stream into parallel data that can be processed by higher layers of a communication layer architecture. In a variety of embodiments, in the power-up mode, the SerDes transmitter 212 and the SerDes receiver 218 may consume full operational power.

The power-down mode may refer to a low-power state in which a component of the system 200 powers down or completely shuts off its internal circuits and functions to save energy when the component is not actively transmitting or receiving data. In various embodiments, the SerDes transmitter 212 may enter the power-down mode during idle periods, but during active operation, the SerDes transmitter 212 may run at full power to ensure reliable data transmission. In the power-down mode, the SerDes transmitter 212 may substantially reduce its power consumption by shutting down or idling components such as a serializer, a clock generator, and other active circuits. Further, in the power-down mode, the SerDes receiver 218 may reduce power consumption or completely shut down its internal circuits and functions to conserve energy when the SerDes receiver 218 is not actively receiving or deserializing data. In the power-down mode, the SerDes receiver 218 may substantially reduce its power consumption by shutting down or idling components such as the CDR mechanism, signal equalization circuits, and other active circuits. In the power-down mode, the SerDes transmitter 212 and the SerDes receiver 218 may be inactive, minimizing power consumption while preserving the ability to quickly return to full operational status when needed.

In more embodiments, at a transmitter side, the system 200 may include a transmitter packet buffer 202, a MAC transmitter 204, and the SerDes transmitter 212, and at a receiver side, the system 200 may include the SerDes receiver 218, a MAC receiver 220, and a receiver packet buffer 224. The transmitter packet buffer 202 may hereinafter be referred to as a “Tx packet buffer 202,” and the receiver packet buffer 224 may hereinafter be referred to as an “Rx packet buffer 224.” The Tx packet buffer 202 may store data packets, herein referred to as “data”, that may be ready for transmission. When a network device needs to transmit data, the data may be first stored in the Tx packet buffer 202. The Tx packet buffer 202 may facilitate data flow and can temporarily hold the data until the data is ready for transmission. The MAC transmitter 204 may be a component within the MAC layer of the OSI model, that prepares and processes the data for transmission over a physical network. The MAC transmitter 204 may format the data into Ethernet frames and attach a MAC header, which includes source and destination MAC addresses, as well as control information, thereto. In additional embodiments, the MAC transmitter 204 may also handle tasks such as error checking by adding, for example, a checksum or a Cyclic Redundancy Check (CRC), ensuring that the data is in a proper format for transmission. The MAC transmitter 204 may include a multiplexer 206 and a data pipeline 208. The multiplexer 206 may combine multiple data inputs, for example, pending data for processing and idle data patterns into a single output data stream that can be transmitted over a physical medium, for example, Ethernet cables or fiber optic cables. The multiplexer 206 may utilize, for example, time-division multiplexing or a frequency-division multiplexing to combine the data inputs. In further embodiments, the data pipeline 208 may be configured as a pipeline logic configured to receive the combined data, process the combined data, and provide the processed data to the SerDes transmitter 212 for transmission.

In still more embodiments, the system 200 may include a power management logic 210 configured to dynamically manage power of the Ethernet interface. Those skilled in the art will recognize that the power management logic 210 can include various hardware and/or software deployments and can be configured in a variety of ways. In still further embodiments, the power management logic 210 can be configured as a standalone device, exist as a logic in another network device, be distributed among various network devices operating in tandem, or be remotely operated as part of a cloud-based network management system. In still additional embodiments, one or more servers can be configured with the power management logic 210 or can otherwise operate as the power management logic 210. In some more embodiments, the power management logic 210 may operate on one or more servers connected to a communication network, for example, the internet. The communication network can include wired networks or wireless networks. The power management logic 210 can be provided as a cloud-based service that can service remote networks, such as a deployed network. In yet various embodiments, the power management logic 210 may be operated as a distributed logic across multiple network devices. For example, a plurality of routers or switches can operate as the power management logic 210 in a distributed manner or may have one specific device operate as the power management logic 210 for all the neighboring or sibling routers or switches.

In yet more embodiments, the power management logic 210 may be configured in the MAC transmitter 204 as illustrated in FIG. 2. In still yet more embodiments, the power management logic 210 may be configured to determine an absence of pending data for processing; complete transmission of residual processed data of an ongoing data transfer operation based on the determined absence of the pending data for the processing; and transmit one or more control indications to the SerDes transmitter 212 based on the completion of the transmission of the residual processed data. The SerDes transmitter 212 may be configured to transition from the power-up mode to the power-down mode based on the control indication(s).

The Tx packet buffer 202 may accumulate part of the data before transmission and signal to the power management logic in the MAC transmitter 204, when the Tx packet buffer 202 is empty or non-empty. In many further embodiments, the power management logic 210 may determine the absence or presence of the pending data for processing based on a packet availability status message 226 signaled by the Tx packet buffer 202. The higher layers of the communication layer architecture, for example, the network layer or the transport layer may generate and hand-off the data to the Tx packet buffer 202. The Tx packet buffer 202 can hold the data temporarily until the data is ready for transmission. When the Tx packet buffer 202 is non-empty, the Tx packet buffer 202 may signal availability of the data to the power management logic 210 in the MAC transmitter 204 via the packet availability status message 226. In response to this packet availability status message 226, the power management logic 210 may transmit a signal 228 indicating a start operation to the multiplexer 206. In response to the signal 228 corresponding to the start operation, the multiplexer 206 may receive the data (denoted as “packets 236”) from the Tx packet buffer 202. In many additional embodiments, the multiplexer 206 may generate idle data patterns 238 for handling idle periods in data transmission. The multiplexer 206 may combine the data and the idle data patterns 238 into a single output data stream 240 that can be transmitted to the data pipeline 208, and in turn to the SerDes transmitter 212 via a parallel data bus 248 for further processing and transmission. This transmission of the single output data stream 240 from the data pipeline 208 to the SerDes transmitter 212 via the parallel data bus 248 may be referred to as the “ongoing data transfer operation”.

In still yet further embodiments, the SerDes transmitter 212 may transmit a signal, for example, a SIGNAL_OK signal 244, to the power management logic 210 and the data pipeline 208 of the MAC transmitter 204, to indicate that the serial data lines 214 and 216 are stable and the SerDes system is ready for a reliable data transfer from the data pipeline 208. In an example, when the SIGNAL_OK signal 244 is asserted, for example, typically a high signal “1”, the SIGNAL_OK signal 244 may inform the MAC transmitter 204 that the link between the SerDes transmitter 212 and the SerDes receiver 218 is functioning correctly. The MAC transmitter 204 may then initiate transmission of the data to the SerDes transmitter 212. If the SIGNAL_OK signal 244 is not asserted, for example, typically a low signal “0”, the SIGNAL_OK signal 244 may indicate that the link is not yet ready, possibly due to issues such as poor signal integrity, lack of synchronization, or initialization problems, and in response to the SIGNAL_OK signal 244, the MAC transmitter 204 may not transmit any data to the SerDes transmitter 212.

In still yet additional embodiments, the SerDes transmitter 212 may generate and transmit a clock signal, for example, a TX_CLK signal 246, to the MAC transmitter 204. The TX_CLK signal 246 may be a high frequency clock signal configured to synchronize transmission of the data and maintain proper timing during the transmission. In several embodiments, the MAC transmitter 204 may utilize the TX_CLK signal 246 to time the transmission of the data to the SerDes transmitter 212. Since high-speed serial data lines 214 and 216 such as those utilized in the SerDes system typically use a different clocking scheme compared to parallel data systems, the TX_CLK signal 246 may ensure that the data is transmitted at the correct rate, thereby maintaining proper synchronization between the SerDes transmitter 212 and the MAC transmitter 204.

In response to receiving the parallel data via the parallel data bus 248, the SerDes transmitter 212, operating in the power-up mode, may serialize the parallel data from the MAC transmitter 204 into a serial data stream suitable for transmission over the physical medium. The SerDes transmitter 212 may ensure that the serial data stream is transmitted bit by bit, maintaining high throughput and reducing the number of pins or wires needed for transmission. The SerDes transmitter 212 may transmit the serial data stream to the SerDes receiver 218 via the serial data line 214. The SerDes receiver 218, operating in the power-up mode, may receive the incoming serial data stream via the serial data line 216 and convert the serial data stream into parallel data for further processing by the MAC receiver 220. In several more embodiments, the received serial data stream from the SerDes transmitter 212 may be free of one or more idle data patterns. The SerDes receiver 218 may transmit the parallel data to the MAC receiver 220 via a parallel data bus 250. In numerous embodiments, the MAC receiver 220 may include a data pipeline 222 configured as a pipeline logic to receive and process the parallel data. The MAC receiver 220 may process the received parallel data, for example, by stripping off the MAC header, checking for errors through the checksum or the CRC), extracting payload data after verifying the destination MAC address, and removing the idle data patterns. In numerous additional embodiments, the MAC receiver 220 may handle flow control or retransmission requests. The MAC receiver 220 may transmit the processed parallel data (denoted as “packets 256”) to the Rx packet buffer 224. The Rx packet buffer 224 may temporarily store the processed parallel data, preventing overflow or loss. The Rx packet buffer 224 may manage the flow of incoming parallel data, ensuring that the parallel data is not lost if the system 200 is busy processing other tasks.

When the Tx packet buffer 202 is empty, the Tx packet buffer 202 may signal unavailability of the data to the power management logic 210 in the MAC transmitter 204 via the packet availability status message 226. In response to the packet availability status message 226, the power management logic 210 may transmit a signal 228 indicating a stop operation to the multiplexer 206. In response to the signal 228 corresponding to the stop operation, the multiplexer 206 may discontinue the reception of the data from the Tx packet buffer 202, the generation of the idle data patterns 238, and the transmission of the single output data stream 240 to the data pipeline 208. The data pipeline 208 may then proceed to complete the transmission of the residual processed data present in the data pipeline 208. The power management logic 210 may transmit one or more control indications to the SerDes transmitter 212 to transition the SerDes transmitter 212 from the power-up mode to the power-down mode. In further additional embodiments, the control indication may include an indication of a transaction 230, for example, a last transaction including a last bit of the residual processed data. The power management logic 210 may transmit the control indication including the indication of the transaction 230 to the SerDes transmitter 212. In response to receiving the indication of the transaction 230, the SerDes transmitter 212 may receive the last bit of the residual processed data from the data pipeline 208 via the parallel data bus 248. In many embodiments, when the data pipeline 208 completes the transmission of the residual processed data, the data pipeline 208 may signal its empty status 242 to the power management logic 210. Further, in a number of embodiments, the control indication may include a power-transition signal configured to trigger the transition of the SerDes transmitter 212 from the power-up mode to the power-down mode. After receiving the last bit of the residual processed data from the data pipeline 208 via the parallel data bus 248, in response to receiving the power-transition signal, the SerDes transmitter 212 may exit the power-up mode and enter the power-down mode.

When new data is generated and stored in the Tx packet buffer 202, the Tx packet buffer 202 may signal availability of the data to the power management logic 210 in the MAC transmitter 204 via the packet availability status message 226. In response to the packet availability status message 226, the power management logic 210 may determine a presence of pending data in the Tx packet buffer 202 for processing; and transmit another one or more control indications to the SerDes transmitter 212 based on the determined presence of the pending data for processing. In a variety of embodiments, the control indication may include a power-transition signal, for example, an ASYNC_POWERUP signal 232, configured to trigger the transition of the SerDes transmitter 212 from the power-down mode to the power-up mode. The ASYNC_POWERUP signal 232 may indicate that the SerDes transmitter 212 is being powered on asynchronously, that is, without waiting for a specific clock signal or synchronization from other parts of the system 200. The term “ASYNC” in the ASYNC_POWERUP signal 232 may emphasize that this power-transition signal may be functional for cases in low power, the clock signal may not be available. In response to receiving the ASYNC_POWERUP signal 232, the SerDes transmitter 212 may transition from the power-down mode to the power-up mode and transmit feedback, for example, a READY signal 234, to the power management logic 210 in the MAC transmitter 204 regarding readiness to receive the pending data. In response to receiving the READY signal 234 from the SerDes transmitter 212, the power management logic 210 in the MAC transmitter 204 may transmit a signal 228 indicating the start operation to the multiplexer 206 and the process disclosed above repeats. Further, in response to receiving the READY signal 234 from the SerDes transmitter 212, in various embodiments, the MAC transmitter 204 may transmit the pending data immediately. In more embodiments, in response to receiving the READY signal 234 from the SerDes transmitter 212, the power management logic 210 may transmit a control indication including an indication of a transaction 230, for example, a first transaction or a valid transaction signal configured to trigger the transmission of the pending data to the SerDes transmitter 212. In additional embodiments, the MAC transmitter 204 may transmit the pending data upon the indication of the first transaction or the valid transaction signal assertion.

In further embodiments, the MAC receiver 220 may be configured with a valid-based design, thereby relying on a valid signal to indicate when incoming data is meaningful and ready to be processed. The valid signal may refer to a control line or signal that explicitly marks the validity of the incoming data. The valid signal may indicate when a particular piece of data is ready for processing by the MAC receiver 220. The valid signal may, for example, be a clock signal such as an RX_CLK clock signal 254 or an explicit valid signal such as a VALID_IDX signal 252. In still more embodiments, the VALID_IDX signal 252 may indicate, for example, a first valid bit on the parallel data bus 250. This offset may be a random number, for example, constant 0, for specific SerDes technology, making the VALID_IDX signal 252 redundant. The MAC receiver 220 may utilize the valid signal to identify the start and end of valid data. For example, the MAC receiver 220, operating in a power-up mode, may only process the data when the valid signal is high or asserts a specific logic level, and may discard or ignore any data received when the valid signal is not asserted. In still further embodiments, the MAC receiver 220 may implement a control logic that listens for the valid signal alongside the incoming data. The MAC receiver 220 may capture, interpret, and process the data only when the valid signal is asserted, thereby reducing power consumption. The valid signal may indicate when a complete frame is received and ready to be processed. When the valid signal is de-asserted, the MAC receiver 220 may complete a current frame's processing and begin to look for the next valid frame. In still additional embodiments, to further reduce power consumption, the SerDes receiver 218 may transmit a power-transition signal configured to trigger the transition of the MAC receiver 220 from a power-up mode to a power-down mode. The power-transition signal may then activate any additional power saving circuits in the MAC receiver 220.

In some more embodiments, the SerDes receiver 218 may transmit a control indication including, for example, a SIGNAL_OK signal, to the MAC receiver 220 indicating that the SerDes receiver 218 has lost its synchronization due to a device failure, for example, a cable hangup, a hardware failure, or the like. This SIGNAL_OK signal may be reused to indicate any failure in the power-down mode of the SerDes transmitter 212 and/or the SerDes receiver 218, that requires a transition from the power-down mode to the power-up mode and a link re-establishment moving to a link down state.

In yet various embodiments, the SerDes receiver 218 may execute a power management logic configured to determine that the received data corresponds to a last valid transaction or a first valid transaction; and transmit one or more control indications to the MAC receiver 220 based on the received data corresponding to the last valid transaction or the first valid transaction. In yet more embodiments, based on the received data corresponding to the first valid transaction, the power management logic may transmit a control indication including a first valid signal, for example, a VALID_IDX signal 252, configured to trigger the transition of the MAC receiver 220 from a power-down mode to a power-up mode, where the first valid signal may include a first valid bit index associated with the received data. In still yet more embodiments, based on the received data corresponding to the first valid transaction, the power management logic may transmit a control indication including a power-transition signal, for example, an ASYNC_POWERUP signal, configured to trigger the transition of the MAC receiver 220 from a power-down mode to a power-up mode. The ASYNC_POWERUP signal may indicate that the MAC receiver 220 is being powered on asynchronously, that is, without waiting for a specific clock signal or synchronization from other parts of the system 200. The term “ASYNC” in the ASYNC_POWERUP signal may emphasize that this power-transition signal may be functional for cases in low power, the clock signal may not be available. In response to receiving the ASYNC_POWERUP signal, the MAC receiver 220 may transition from the power-down mode to the power-up mode.

Further, in many further embodiments, based on the received data corresponding to the last valid transaction, the power management logic may transmit a control indication including a last valid signal configured to trigger the transition of the MAC receiver 220 from a power-up mode to a power-down mode, where the last valid signal may include a last valid bit index associated with the received data. In many additional embodiments, based on the received data corresponding to the last valid transaction, the power management logic may transmit a control indication including a power-transition signal configured to trigger the transition of the MAC receiver 220 from a power-up mode to a power-down mode.

Although a specific embodiment for a system 200 for dynamically managing power of an Ethernet interface suitable for carrying out the various steps, processes, methods, and operations described herein is discussed with respect to FIG. 2, any of a variety of systems and/or processes may be utilized in accordance with embodiments of the disclosure. For example, in still yet further embodiments, the power management logic 210 may be integrated within another network device. In an example, a Wireless Local Area Network (LAN) Controller, denoted as “WLC,” may have an integrated power management logic 210 that the WLC can utilize to monitor or control power consumption of a plurality of network devices to which the WLC is connected and manage network events received by the network devices, via either a wired connection or a wireless connection. In still yet additional embodiments, the power management logic 210 may be provided as a device or a software separate from the WLC or the power management logic 210 may be partially or wholly integrated into the WLC. The elements depicted in FIG. 2 may also be interchangeable with other elements of FIG. 1 and FIGS. 3-10 as required to realize a particularly desired embodiment.

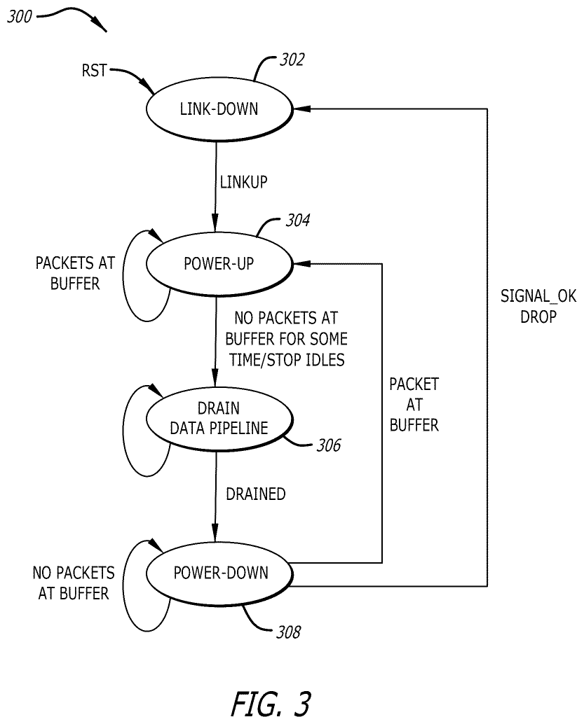

Referring to FIG. 3, a schematic diagram illustrating a Finite State Machine (FSM) 300 associated with dynamic power management of an Ethernet interface in accordance with various embodiments of the disclosure is shown. Consider an example where a system for dynamic power management of the Ethernet interface may include a transmitter packet buffer, a MAC transmitter, and a SerDes transmitter at the transmitter side. The transmitter packet buffer may hereinafter be referred to as a “Tx packet buffer.” In many embodiments, a power management logic may be configured in the MAC transmitter and may implement the FSM 300 to control the behavior of various components of the system based on different states and transitions. The power management logic may detect a loss of a communication link between the SerDes transmitter and a SerDes receiver of the Ethernet interface, indicating a link-down state 302 of the FSM 300. The link-down state 302 may indicate that the communication link between the SerDes transmitter and the SerDes receiver may not be operational, for example, due to a physical disconnect, a cable failure, power issues, or communication errors. In the FSM 300, the link-down state 302 may refer to a “failure” state or an “idle” state, where the system may wait for an event or a condition that may lead to a recovery of the communication link, for example, through a power restoration or a cable reconnection, and trigger a reactivation of the communication link. In a number of embodiments, the power management logic may issue a reset signal to reinitialize and reactivate the communication link. When the communication link is reactivated, the system may detect a “linkup” condition and enter a power-up state 304. In a variety of embodiments, in the power-up state 304, the MAC transmitter and the SerDes transmitter may operate in a power-up mode. In various embodiments, the power management logic may transmit a control indication including a power-transition signal, for example, an ASYNC_POWERUP signal, to trigger a transition of the SerDes transmitter from a power-down mode to the power-up mode. The ASYNC_POWERUP signal may indicate that the SerDes transmitter is being powered on asynchronously, that is, without waiting for a specific clock signal or synchronization from other parts of the system. In the power-up state 304, the MAC transmitter, operating in the power-up mode, may monitor the Tx packet buffer for presence of data, herein referred to as “packets”, and await a packet availability status message from the Tx packet buffer. The system may remain in the power-up state 304 as long as the packets are present in the Tx packet buffer. The Tx packet buffer may indicate the presence or absence of the packets in the packet availability status message.

When the power management logic detects that there are no packets in the Tx packet buffer for a configured time period, the power management logic may transmit a signal instructing the MAC transmitter to terminate transmission of one or more idle data patterns to the SerDes transmitter. In response to this signal, the MAC transmitter may discontinue generation and transmission of the idle data pattern(s) and proceed to drain 306 residual processed packets present in its data pipeline. The MAC transmitter may continue draining the data pipeline until the data pipeline is completely drained or empty. In more embodiments, the power management logic may transmit a control indication including an indication of a last transaction including a last bit of the residual processed data to the SerDes transmitter. The data pipeline may transmit a signal indicating an empty status to the power management logic when the data pipeline is completely drained.

In response to the empty status, the power management logic may transmit a control indication including a power-transition signal that triggers a transition of the SerDes transmitter from the power-up mode to a power-down mode, thereby triggering the system to enter a power-down state 308 of the FSM 300. The system may remain in the power-down state 308 until there are no packets in the Tx packet buffer. If new packets are generated and stored in the Tx packet buffer, the power management logic may transmit a control indication including a power-transition signal that triggers a transition of the SerDes transmitter from the power-down mode to the power-up mode, thereby causing the system to exit the power-down state 308 and enter the power-up state 304 of the FSM 300.

In additional embodiments, the MAC transmitter may receive a SIGNAL_OK signal from the SerDes transmitter, indicating that the communication link between the SerDes transmitter and the SerDes receiver is stable, and valid signals are being transmitted and received. The SIGNAL_OK signal may be utilized to check the integrity of the communication link. If the integrity of the communication link is sufficient, The SIGNAL_OK signal may be asserted, indicating that the communication link is up and the system can operate normally. Conversely, if the integrity of the communication link drops or the communication link fails, the SIGNAL_OK signal may be de-asserted or go low, indicating a problem with the communication link. In further embodiments, when the system is in the power-down state 308, the system may attempt to power up or wake from the power-down state 308. The system may further attempt to detect a status of the communication link and checks the SIGNAL_OK signal to determine whether the communication link is active. A low or drop of the SIGNAL_OK signal may indicate that the communication link cannot be established or is not functioning properly. The FSM 300 may transition to the link-down state 302, indicating that the communication link is not available for communication. The SIGNAL_OK drop, that is, a de-assertion of the SIGNAL_OK signal after power-up, may cause the system to transition from the power-down state 308 to the link-down state 302 because the system recognizes that, although the system is powered up, the communication link is not functioning correctly or has not been established.

Although a specific embodiment for a finite state machine 300 associated with dynamic power management of an Ethernet interface suitable for carrying out the various steps, processes, methods, and operations described herein is discussed with respect to FIG. 3, any of a variety of systems and/or processes may be utilized in accordance with various embodiments of the disclosure. For example, besides utilizing the SIGNAL_OK signal to determine the status of the communication link, in still more embodiments, the power management logic may utilize other techniques to determine the integrity of the communication link such as bit error rate monitoring, detecting a clock synchronization failure, a carrier sense mechanism, detecting a handshake failure, signal pattern recognition, or the like. The elements depicted in FIG. 3 may also be interchangeable with other elements of FIG. 1-2 and FIG. 4-10 as required to realize a particularly desired embodiment.

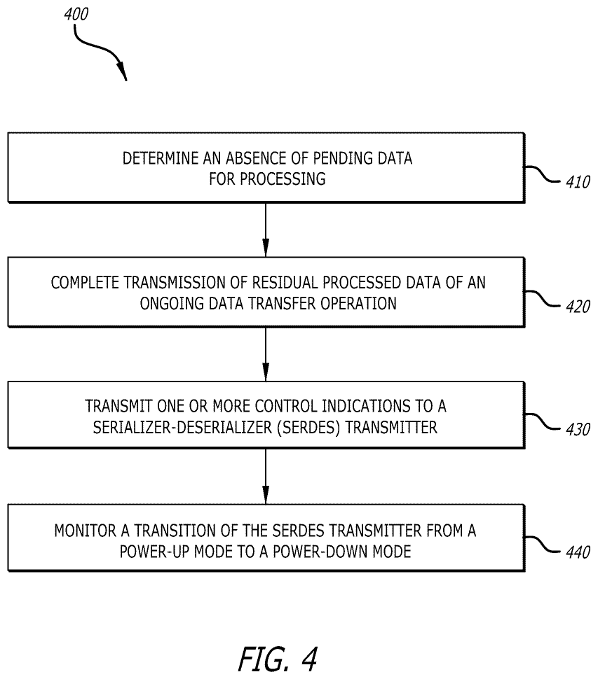

Referring to FIG. 4, a flowchart depicting a process 400 for dynamically managing power of an Ethernet interface associated with transmission of data in accordance with various embodiments of the disclosure is shown. In many embodiments, the process 400 may determine an absence of pending data for processing (block 410). In a number of embodiments, the process 400 may determine the absence of the pending data based on a data buffer being empty. The data buffer may store the pending data for processing by a MAC transmitter of the Ethernet interface. In a variety of embodiments, the data buffer may be a transmitter packet buffer, hereinafter referred to as a “Tx packet buffer,” disposed on a transmitter side of the Ethernet interface. The Tx packet buffer may store the data that may be ready for transmission and processing at the MAC transmitter. When a network device needs to transmit data, the data may be first stored in the Tx packet buffer. When the Tx packet buffer is empty, the Tx packet buffer may signal unavailability of the data to the MAC transmitter via a packet availability status message. In various embodiments, the process 400 may determine the absence of the pending data based on the Tx packet buffer being empty for a configured time period.

In more embodiments, the process 400 may complete transmission of residual processed data of an ongoing data transfer operation (block 420). The residual processed data may be stored in a data pipeline of the MAC transmitter. In additional embodiments, the data pipeline may be operably coupled to the Tx packet buffer, for example, via a multiplexer of the MAC transmitter. The ongoing data transfer operation may refer to transmission of a single output data stream from the data pipeline to a SerDes transmitter via a parallel data bus. The data pipeline may be configured to provide the residual processed data of the ongoing data transfer operation to the SerDes transmitter for transmission. The process 400 may complete the transmission of the residual processed data of the ongoing data transfer operation based on the determined absence of the pending data for the processing. In further embodiments, based on the determined absence of the pending data, the process 400 may terminate a transmission of one or more idle data patterns to the SerDes transmitter.

In still more embodiments, the process 400 may transmit one or more control indications to a SerDes transmitter (block 430). The process 400 may transmit the control indication(s) to the SerDes transmitter based on the completion of the transmission of the residual processed data. In still further embodiments, the control indication(s) may include an indication of a last transaction including a last bit of the residual processed data. The process 400 may transmit the control indication including the indication of the last transaction to the SerDes transmitter. In response to receiving the indication of the last transaction, the SerDes transmitter may receive the last bit of the residual processed data from the data pipeline via the parallel data bus. In still additional embodiments, when the data pipeline completes the transmission of the residual processed data, the data pipeline may signal its empty status. In some more embodiments, the control indication(s) may include a power-transition signal configured to trigger the transition of the SerDes transmitter from the power-up mode to the power-down mode. The SerDes transmitter is configured to transition from the power-up mode to the power-down mode based on the control indication(s).

In yet various embodiments, the process 400 may monitor a transition of the SerDes transmitter from a power-up mode to a power-down mode (block 440). In yet more embodiments, in the power-down mode, the SerDes transmitter may disable its transmission circuitry to save power. For example, in the power-down mode, the SerDes transmitter may substantially reduce its power consumption by shutting down or idling components such as a serializer, a clock generator, and other active circuits. Further, in the power-down mode, the SerDes transmitter may no longer transmit the data to the SerDes receiver, and the communication link may become inactive or may enter an idle state. In still yet more embodiments, the process 400 may monitor the state of the SerDes transmitter indirectly through the Ethernet PHY layer. The Ethernet PHY lay may refer to a physical layer interface between the MAC transmitter and the SerDes transmitter, that may handle a communication of a link status and a power state. In many further embodiments, the MAC transmitter may listen to the link status signals provided by the Ethernet PHY layer, thereby allowing the process 400 to monitor the transition of the SerDes transmitter from the power-up mode to the power-down mode.

Although a specific embodiment for a process 400 for dynamically managing power of an Ethernet interface associated with transmission of data suitable for carrying out the various steps, processes, methods, and operations described herein is discussed with respect to FIG. 4, any of a variety of systems and/or processes may be utilized in accordance with embodiments of the disclosure. For example, when the SerDes transmitter transitions from the power-up mode to the power-down mode, the process 400 may also trigger the MAC transmitter to transition from the power-up mode to the power-down mode to further reduce power consumption. The elements depicted in FIG. 4 may also be interchangeable with other elements of FIG. 1-3 and FIG. 5-10 as required to realize a particularly desired embodiment.

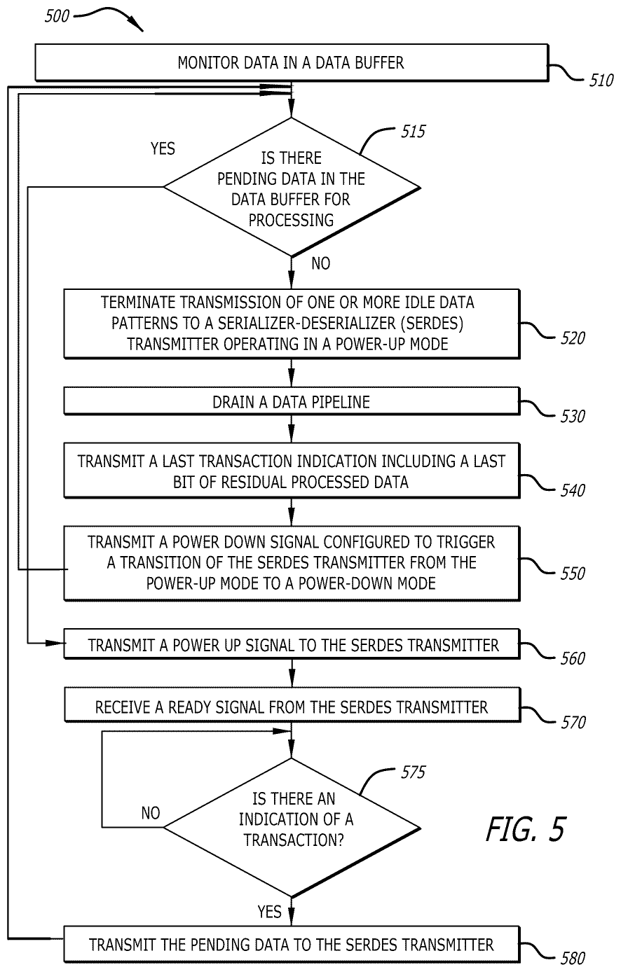

Referring to FIG. 5, a flowchart depicting a process 500 for dynamically managing power of an Ethernet interface through power mode transitions in accordance with various embodiments of the disclosure is shown. In many embodiments, the process 500 may monitor data in a data buffer (block 510). The data buffer may store pending data for processing by a MAC transmitter of the Ethernet interface. In a number of embodiments, the data buffer may be a transmitter packet buffer disposed on a transmitter side of the Ethernet interface. The data buffer may store the data that may be ready for transmission and processing at the MAC transmitter.

In a variety of embodiments, the process 500 may determine whether there is pending data in the data buffer for processing (block 515). When a network device needs to transmit data, the data may be first stored in the data buffer. The process 500 may determine the absence or presence of pending data for processing based on a packet availability status message signaled to the MAC transmitter by the data buffer. The packet availability status message may indicate availability or unavailability of the pending data in the data buffer. In various embodiments, the process 500 may determine the absence of the pending data based on the data buffer being empty for a configured time period.

In more embodiments, in response to determining that there is no pending data in the data buffer for processing, the process 500 may terminate transmission of one or more idle data patterns to a SerDes transmitter operating in a power-up mode (block 520). In the power-up mode, the SerDes transmitter may be ready to serialize data from a parallel format of multiple bits to a high-speed serial data stream and transmit the high-speed serial data stream over a communication link. Data must always be available on a parallel data bus of the MAC transmitter, as the SerDes transmitter cannot stop transmitting data. The SerDes transmitter cannot stop transmitting the data because the CDR mechanism of the SerDes receiver must receive network traffic transactions for its basic operation, for clock recovery, and to remain locked. If there is no data in the data buffer, the MAC transmitter may generate idle data patterns for transmission by the SerDes transmitter to allow the SerDes transmitter to keep transmitting data. However, in additional embodiments, to reduce power consumption by the SerDes receiver, the process 500 may terminate transmission of the idle data pattern(s) to the SerDes transmitter operating in the power-up mode and therefore, a serial data stream received by the SerDes receiver from the SerDes transmitter may be free of one or more idle data patterns. By terminating the transmission of the idle data pattern(s), the SerDes receiver may not need to consume power for removing the idle data pattern(s) at the receiver side.

In further embodiments, the process 500 may drain a data pipeline (block 530). In response to determining that there is no pending data in the data buffer for processing, the process 500 may proceed to drain residual processed data present in the data pipeline of the MAC transmitter. The process 500 may drain the residual processed data as a single output data stream from the data pipeline to the SerDes transmitter via the parallel data bus in an ongoing data transfer operation. The process 500 may continue draining the data pipeline until the data pipeline is completely drained or empty.

In still more embodiments, the process 500 may transmit a last transaction indication including a last bit of residual processed data (block 540). The process 500 may transmit the last transaction indication from the MAC transmitter to the SerDes transmitter. In response to transmitting the last transaction indication to the SerDes transmitter, the process 500 may drain the last bit of the residual processed data from the data pipeline to the SerDes transmitter via the parallel data bus. The data pipeline may indicate an empty status when the data pipeline is completely drained.

In still further embodiments, the process 500 may transmit a power down signal configured to trigger a transition of the SerDes transmitter from the power-up mode to a power-down mode (block 550). The process 500 may transmit the power down signal in the form of a control indication to the SerDes transmitter. The SerDes transmitter may transition from the power-up mode to the power-down mode based on the control indication. In the power-down mode, the SerDes transmitter may substantially reduce its power consumption by shutting down or idling components such as a serializer, a clock generator, and other active circuits. In still additional embodiments, the process 500 may then proceed to reiterate the step of determining whether there is pending data in the data buffer for processing (block 515).

In some more embodiments, in response to determining that there is pending data in the data buffer for processing, the process 500 may transmit a power up signal to the SerDes transmitter (block 560). The power up signal may refer to a power transition signal configured to trigger the transition of the SerDes transmitter from the power-down mode to the power-up mode. In yet various embodiments, the power up signal may be an ASYNC_POWERUP signal configured to trigger the transition of the SerDes transmitter from the power-down mode to the power-up mode. The ASYNC_POWERUP signal may indicate that the SerDes transmitter is being powered on asynchronously, that is, without waiting for a specific clock signal or synchronization. The process 500 may transmit the power up signal in the form of a control indication to the SerDes transmitter. The SerDes transmitter may transition from the power-down mode to the power-up mode based on the control indication. In the power-up mode, the SerDes transmitter may be ready to serialize the data from a parallel format of multiple bits to a high-speed serial data stream and transmit the high-speed serial data stream over the communication link.

In yet more embodiments, the process 500 may receive a READY signal from the SerDes transmitter (block 570). In response to receiving the ASYNC_POWERUP signal, the SerDes transmitter may transition from the power-down mode to the power-up mode and transmit the READY signal as feedback to the MAC transmitter regarding readiness to receive the pending data. In response to receiving the READY signal from the SerDes transmitter, the process 500 may transmit a signal indicating the start operation to a multiplexer of the MAC transmitter. The multiplexer is configured to generate a single output data stream that can be transmitted to the data pipeline, and in turn to the SerDes transmitter via the parallel data bus for further processing and transmission.

In still yet more embodiments, the process 500 may determine whether there is an indication of a transaction (block 575). In response to receiving the READY signal from the SerDes transmitter, the process 500 may transmit a control indication including an indication of a transaction, for example, a first transaction or a valid transaction signal, to the SerDes transmitter. The indication of the first transaction or the valid transaction signal may trigger the transmission of the pending data to the SerDes transmitter. In many further embodiments, absence of the indication of the first transaction or the valid transaction signal may trigger an immediate transmission of the pending data to the SerDes transmitter.

In many additional embodiments, in response to determining that there is an indication of a transaction, the process 500 may transmit the pending data to the SerDes transmitter (block 580). In still yet further embodiments, the process 500 may transmit the pending data from the MAC transmitter upon the indication of the first transaction or the valid transaction signal assertion. The process 500 may transmit the pending data from the data pipeline of the MAC transmitter to the SerDes transmitter via the parallel data bus. The SerDes transmitter operating in the power-up mode may serialize the parallel data to a high-speed serial data stream and transmit the high-speed serial data stream over a communication link. In still yet additional embodiments, the process 500 may then continue determining whether there is pending data in the data buffer for processing (block 515). In several embodiments, in response to determining that there is an indication of a transaction, the process 500 may reiterate the step of determining that an indication of a transaction is rreceived (block 575).

Although a specific embodiment for a process 500 for dynamically managing power of an Ethernet interface through power mode transitions suitable for carrying out the various steps, processes, methods, and operations described herein is discussed with respect to FIG. 5, any of a variety of systems and/or processes may be utilized in accordance with embodiments of the disclosure. For example, in several embodiments, the process 500 may implement a software-controlled Power Management Unit (PMU) configured to manage the transitions of the power modes of the SerDes transmitter. In several more embodiments, the SerDes transmitter may automatically detect idle or low-traffic periods through internal monitoring, for example, by detecting no data transmission, and autonomously enter the power-down mode without requiring explicit control from the PMU. The elements depicted in FIG. 5 may also be interchangeable with other elements of FIG. 1-4 and FIG. 6-10 as required to realize a particularly desired embodiment.

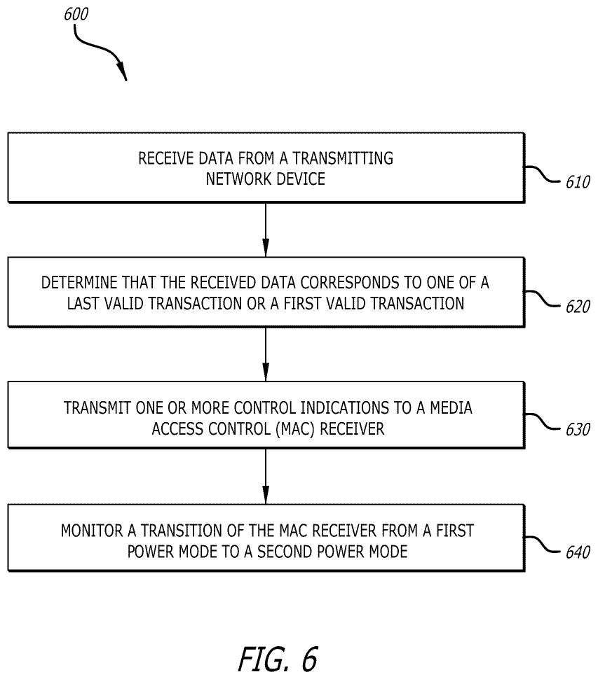

Referring to FIG. 6, a flowchart depicting a process 600 for dynamically managing power of an Ethernet interface associated with reception of data in accordance with various embodiments of the disclosure is shown. In many embodiments, the process 600 may receive data from a transmitting network device (block 610). The data may include, for example, a high-speed serial data stream converted from a parallel format of multiple bits. The transmitting network device may be a SerDes transmitter of the Ethernet interface. The process 600 may receive the data at a SerDes receiver of the Ethernet interface. The process 600 may receive the data via a serial data line. In a number of embodiments, the received data from the transmitting network device is free of one or more idle data patterns.

In a variety of embodiments, the process 600 may determine that the received data corresponds to one of a last valid transaction or a first valid transaction (block 620). The process 600 may determine that the received data corresponds to a last valid transaction or a first valid transaction at the SerDes receiver. In various embodiments, the received data may include delimiters or special characters that help the SerDes receiver identify the boundaries of valid data. In more embodiments, the process 600 may determine that the received data corresponds to a last valid transaction by inspecting the data and identifying a specific marker, delimiter, or pattern at the end of each frame or packet. In additional embodiments, the process 600 may determine that the received data corresponds to a first valid transaction by inspecting the data and identifying a specific marker, delimiter, or pattern at the start of each frame or packet.

In further embodiments, the process 600 may transmit one or more control indications to a Media Access Control (MAC) receiver (block 630). The MAC receiver may be coupled to the SerDes receiver. The process 600 may transmit the control indication(s) from the SerDes receiver to the MAC receiver. The process 600 may transmit the control indication(s) to the MAC receiver based on the received data corresponding to the last valid transaction or the first valid transaction. Based on the control indication(s), the MAC receiver may be configured to transition from a first power mode to a second power mode. In still more embodiments, based on the received data corresponding to the first valid transaction: the control indication(s) may include a first valid signal configured to trigger the transition of the MAC receiver, where the first valid signal may include a first valid bit index associated with the received data, and where the transition from the first power mode to the second power mode may include a transition from a power-down mode to a power-up mode. In still further embodiments, based on the received data corresponding to the first valid transaction: the control indication(s) may include a power-transition signal configured to trigger the transition of the MAC receiver, where the transition from the first power mode to the second power mode may include a transition from a power-down mode to a power-up mode. In still additional embodiments, based on the received data corresponding to the last valid transaction: the control indication(s) may include a last valid signal configured to trigger the transition of the MAC receiver, where the last valid signal may include a last valid bit index associated with the received data, and where the transition from the first power mode to the second power mode may include a transition from a power-up mode to a power-down mode. In some more embodiments, based on the received data corresponding to the last valid transaction: the control indication(s) may include a power-transition signal configured to trigger the transition of the MAC receiver, where the transition from the first power mode to the second power mode may include a transition from a power-up mode to a power-down mode.

In yet various embodiments, the process 600 may monitor a transition of the MAC receiver from a first power mode to a second power mode (block 640). The SerDes receiver may transmit the parallel data to the MAC receiver operating in a power-up mode via a parallel data bus. In yet more embodiments, the MAC receiver may include a data pipeline configured as a pipeline logic to receive and process the parallel data. In still yet more embodiments, the received parallel data is free of one or more idle data patterns. The MAC receiver may process the received parallel data, for example, by stripping off the MAC header, checking for errors through the checksum or the CRC), and extracting payload data after verifying the destination MAC address. In many further embodiments, the MAC receiver may handle flow control or retransmission requests. The MAC receiver may transmit the processed parallel data to a data buffer at the receiver side. The data buffer may temporarily store the processed parallel data, preventing overflow or loss. The data buffer may manage the flow of incoming parallel data, ensuring that the parallel data is not lost if the system is busy processing other tasks.

Although a specific embodiment for a process 600 for dynamically managing power of an Ethernet interface associated with reception of data suitable for carrying out the various steps, processes, methods, and operations described herein is discussed with respect to FIG. 6, any of a variety of systems and/or processes may be utilized in accordance with embodiments of the disclosure. For example, in many additional embodiments, if the SerDes receiver indicates a link-down state, for example, when the connection is lost or disconnected, the MAC receiver may automatically enter a power-down mode since there is no valid data to receive. The elements depicted in FIG. 6 may also be interchangeable with other elements of FIG. 1-5 and FIG. 7-10 as required to realize a particularly desired embodiment.

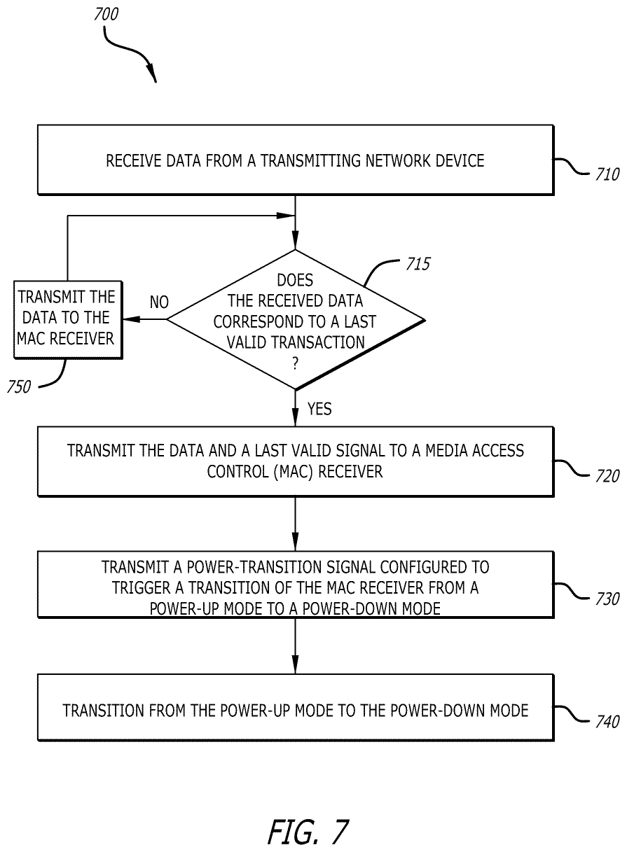

Referring to FIG. 7, a flowchart depicting a process 700 for dynamically managing power of an Ethernet interface associated with reception of data corresponding to a last valid transaction in accordance with various embodiments of the disclosure is shown. In many embodiments, the process 700 may receive data from a transmitting network device (block 710). The data may include, for example, a high-speed serial data stream converted from a parallel format of multiple bits. The transmitting network device may be a SerDes transmitter of the Ethernet interface. The process 700 may receive the data at a SerDes receiver of the Ethernet interface. The process 700 may receive the data via a serial data line. In a number of embodiments, the received data from the transmitting network device is free of one or more idle data patterns.

In a variety of embodiments, the process 700 may determine whether the received data corresponds to a last valid transaction (block 715). The process 700 may determine that the received data corresponds to a last valid transaction at the SerDes receiver. In various embodiments, the received data may include delimiters or special characters that help the SerDes receiver identify the boundaries of valid data. In more embodiments, the process 700 may determine that the received data corresponds to a last valid transaction by inspecting the data and identifying a specific marker, delimiter, or pattern at the end of each frame or packet.

In additional embodiments, in response to determining that the received data corresponds to a last valid transaction, the process 700 may transmit the data and a last valid signal to a MAC receiver (block 720). The last valid signal may include a last valid bit index associated with the received data. In further embodiments, the last valid bit index may mark the end of a valid data stream or transaction and indicate the last bit that was correctly received and verified. In still more embodiments, the last valid bit index may assist in identifying the boundary between valid data and potentially invalid or corrupted data, as well as in determining the synchronization points between the SerDes transmitter and the SerDes receiver. The last valid signal may be configured to trigger the transition of the MAC receiver from a power-up mode to a power-down mode.

In still further embodiments, the process 700 may transmit a power-transition signal configured to trigger a transition of the MAC receiver from a power-up mode to a power-down mode (block 730). The process 700 may transmit a power-transition signal from the SerDes receiver to the MAC receiver. In still additional embodiments, the power-transition signal may activate power saving circuits in the MAC receiver, thereby transitioning the MAC receiver from the power-up mode to the power-down mode. In some more embodiments, to enter the power-down mode, the MAC receiver may disable various internal components to reduce power consumption. For example, the MAC receiver may deactivate pipeline logic associated with a data pipeline of the MAC receiver, may disable the data buffer or transition the data buffer to a power-down state, may gate clocks to internal circuits that are not required when the MAC receiver is in the power-down mode, or the like.

In yet various embodiments, the process 700 may transition from the power-up mode to the power-down mode (block 740). In yet more embodiments, when the MAC receiver transitions from the power-up mode to the power-down mode, the process 700 may transition the SerDes receiver to transition from the power-up mode to the power-down. In the power-down mode, the SerDes receiver may reduce power consumption or completely shut down its internal circuits and functions to conserve energy when the SerDes receiver is not actively receiving or deserializing data. In the power-down mode, the SerDes receiver may substantially reduce its power consumption by shutting down or idling components such as the CDR mechanism, signal equalization circuits, and other active circuits. In the power-down mode, the SerDes receiver may be inactive, minimizing power consumption while preserving the ability to quickly return to full operational status when needed.

In response to determining that the received data does not correspond to a last valid transaction, the process 700 may transmit the data to the MAC receiver (block 750) and reiterate the step of determining whether the received data corresponds to a last valid transaction (block 715). The MAC receiver may receive one transaction per clock signal of the SerDes receiver. In still yet more embodiments, the MAC receiver may perform offset shifting, reconstruct the original data pattern, and transmit the data to a data buffer. As the received data from the SerDes transmitter is free of one or more idle data patterns, the MAC receiver may receive the data from the SerDes receiver free of one or more idle data patterns and as such, does not need to consume additional power for removing the idle data patterns from the received data.

Although a specific embodiment for a process 700 for dynamically managing power of an Ethernet interface associated with reception of data corresponding to a last valid transaction suitable for carrying out the various steps, processes, methods, and operations described herein is discussed with respect to FIG. 7, any of a variety of systems and/or processes may be utilized in accordance with embodiments of the disclosure. For example, in many further embodiments, the process 700 may utilize frame length predetermined or embedded in a frame header of the received data to detect the last valid transaction. The elements depicted in FIG. 7 may also be interchangeable with other elements of FIG. 1-6 and FIG. 8-10 as required to realize a particularly desired embodiment.

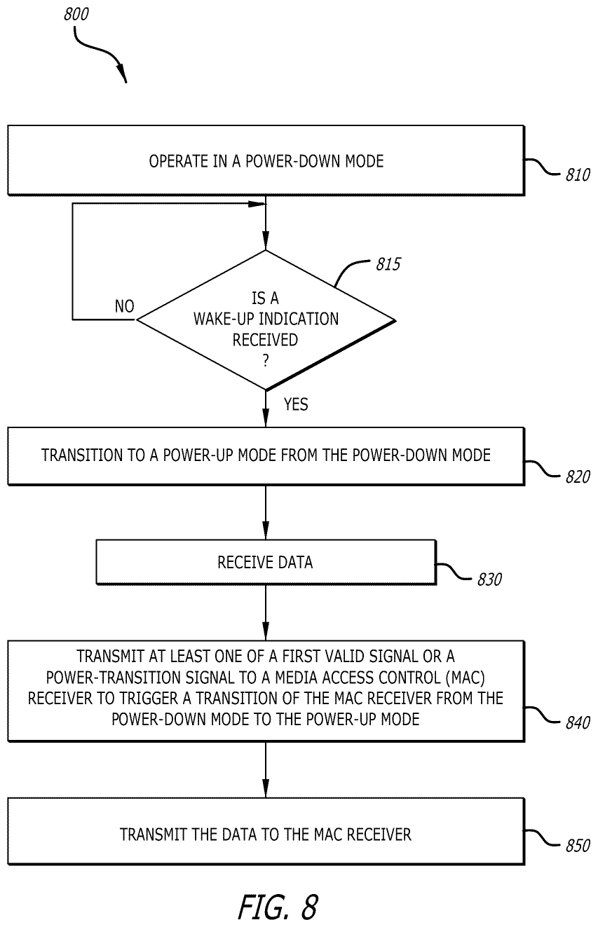

Referring to FIG. 8, a flowchart depicting a process 800 for dynamically managing power of an Ethernet interface associated with reception of data corresponding to a first valid transaction in accordance with various embodiments of the disclosure is shown. In many embodiments, the process 800 may operate in a power-down mode (block 810). The process 800 may operate in the power-down mode at the SerDes receiver. In the power-down mode, the SerDes receiver may reduce power consumption or completely shut down its internal circuits and functions to conserve energy when the SerDes receiver is not actively receiving or deserializing data. In the power-down mode, the SerDes receiver may substantially reduce its power consumption by shutting down or idling components such as the CDR mechanism, signal equalization circuits, and other active circuits. In the power-down mode, the SerDes transmitter and the SerDes receiver may be inactive, minimizing power consumption while preserving the ability to quickly return to full operational status when needed.

In a number of embodiments, the process 800 may determine whether a wake-up indication is received (block 815). The wake-up indication may refer to a signal or a mechanism that triggers the SerDes receiver to exit the power-down mode and resume active operation to process incoming data. This wake-up indication may support dynamic power management by allowing the SerDes receiver to conserve power when no active data is being received, but quickly return to a power-up mode when new data is available or when a communication link is restored. The process 800 may determine whether the wake-up indication is received at the SerDes receiver to transition the SerDes receiver from the power-down mode to the power-up mode.

In a variety of embodiments, in response to determining that the wake-up indication is received, the process 800 may transition to a power-up mode from the power-down mode (block 820). The process 800 may transition to the power-up mode from the power-down mode at the SerDes receiver. The power-up mode may refer to an operational state that the SerDes receiver enters when the SerDes receiver is powered on and initialized for normal data communication including data reception and data transmission. The process 800 may perform the data reception from the SerDes transmitter and the data transmission to a MAC receiver.

In various embodiments, the process 800 may receive data (block 830). When the SerDes receiver transitions to the power-up mode from the power-down mode, the process 800 may receive the data from the SerDes transmitter via a serial data line. The received data may include a serial data stream that was serialized or converted from parallel data by the SerDes transmitter. The SerDes receiver may be configured to perform deserialization. The SerDes receiver may receive and reconstruct the incoming serial data stream back into parallel data that the MAC receiver can process.

In more embodiments, the process 800 may transmit at least one of a first valid signal or a power-transition signal to the MAC receiver to trigger a transition of the MAC receiver from the power-down mode to the power-up mode (block 840). In additional embodiments, the process 800 determine that the received data corresponds to a first valid transaction. In further embodiments, based on the received data corresponding to the first valid transaction, the process 800 may transmit a control indication including the first valid signal, for example, a VALID_IDX signal, configured to trigger the transition of the MAC receiver from the power-down mode to the power-up mode. The first valid signal may include a first valid bit index associated with the received data. In still more embodiments, based on the received data corresponding to the first valid transaction, the power management logic may transmit a control indication including the power-transition signal, for example, an ASYNC_POWERUP signal, configured to trigger the transition of the MAC receiver from the power-down mode to the power-up mode. The ASYNC_POWERUP signal may indicate that the MAC receiver is being powered on asynchronously, that is, without waiting for a specific clock signal or synchronization from other parts. In response to receiving the ASYNC_POWERUP signal, the MAC receiver may transition from the power-down mode to the power-up mode.

In still further embodiments, the process 800 may transmit the data to the MAC receiver (block 850). The process 800 may transmit the data from the SerDes receiver to the MAC receiver over a parallel data bus. The MAC receiver may receive one transaction per clock signal of the SerDes receiver. In still additional embodiments, the MAC receiver may perform offset shifting, reconstruct the original data pattern, and transmit the data to a data buffer. As the received data from the SerDes transmitter is free of one or more idle data patterns, the MAC receiver may receive the data from the SerDes receiver free of one or more idle data patterns and as such, does not need to consume additional power for removing the idle data patterns from the received data. In response to determining that the wake-up indication is not received, the process 800 may continue to determine whether the wake-up indication is received (block 815).

Although a specific embodiment for a process 800 for dynamically managing power of an Ethernet interface associated with reception of data corresponding to a first valid transaction suitable for carrying out the various steps, processes, methods, and operations described herein is discussed with respect to FIG. 8 any of a variety of systems and/or processes may be utilized in accordance with embodiments of the disclosure. For example, in some more embodiments, the process 800 may utilize carrier signal detection or preamble detection where a preamble or a known sequence of bits may be inserted before the actual data to allow the MAC receiver to synchronize and detect the first valid transaction. The elements depicted in FIG. 8 may also be interchangeable with other elements of FIG. 1-7 and FIG. 9-10 as required to realize a particularly desired embodiment.

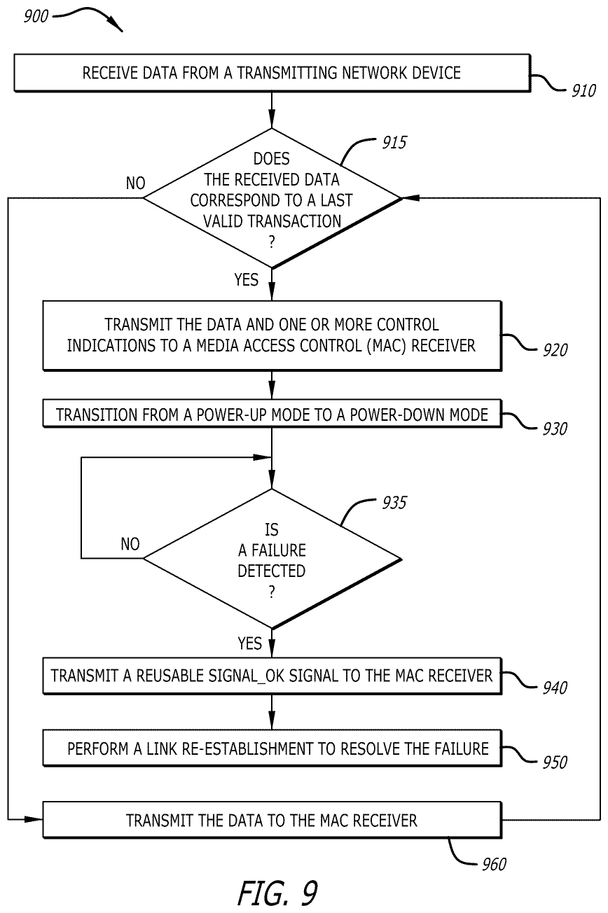

Referring to FIG. 9, a flowchart depicting a process 900 for dynamically managing power of an Ethernet interface to resolve a device failure in accordance with various embodiments of the disclosure is shown. In many embodiments, the process 900 may receive data from a transmitting network device (block 910). The data may include, for example, a high-speed serial data stream converted from a parallel format of multiple bits. The transmitting network device may be a SerDes transmitter of the Ethernet interface. The process 900 may receive the data at a SerDes receiver of the Ethernet interface. The process 900 may receive the data via a serial data line. In a number of embodiments, the received data from the transmitting network device is free of one or more idle data patterns.

In a variety of embodiments, the process 900 may determine whether the received data corresponds to a last valid transaction (block 915). The process 900 may determine that the received data corresponds to a last valid transaction at the SerDes receiver. In various embodiments, the received data may include delimiters or special characters that help the SerDes receiver identify the boundaries of valid data. In more embodiments, the process 900 may determine that the received data corresponds to a last valid transaction by inspecting the data and identifying a specific marker, delimiter, or pattern at the end of each frame or packet. The SerDes receiver may perform deserialization of the received data.

In additional embodiments, in response to determining that the received data corresponds to a last valid transaction, the process 900 may transmit the data and one or more control indications to a MAC receiver (block 920). The MAC receiver may be coupled to the SerDes receiver. The process 900 may transmit the deserialized data or parallel data from the SerDes receiver to the MAC receiver over a parallel data bus. The process 900 may transmit the control indication(s) from the SerDes receiver to the MAC receiver. The process 900 may transmit the control indication(s) to the MAC receiver based on the received data corresponding to the last valid transaction. The last valid transaction may include a last valid signal configured to trigger the transition of the MAC receiver from a power-up mode to a power-down mode. In further embodiments, the last valid signal may include a last valid bit index associated with the received data.

In still more embodiments, the process 900 may transition from a power-up mode to a power-down mode (block 930). The process 900 may transition from the power-up mode to the power-down mode at the SerDes receiver. In the power-down mode, the SerDes receiver may reduce power consumption or completely shut down its internal circuits and functions to conserve energy when the SerDes receiver is not actively receiving or deserializing data. In the power-down mode, the SerDes receiver may substantially reduce its power consumption by shutting down or idling components such as the CDR mechanism, signal equalization circuits, and other active circuits. In the power-down mode, the SerDes receiver may be inactive, minimizing power consumption while preserving the ability to quickly return to full operational status when needed.

In still further embodiments, the process 900 may determine whether a failure is detected (block 935). In still additional embodiments, the process 900 may determine whether a failure is detected at the SerDes receiver. Several failures can occur at the SerDes receiver, impacting its ability to accurately receive, synchronize, and process data from the SerDes transmitter. These failures may arise due to various issues such as signal degradation, hardware malfunctions, or communication protocol violations. The failure may occur, for example, due to a broken or improperly connected transmission medium such as a cable, a fiber, or a Printed Circuit Board (PCB) trace. The failure may also occur, for example, due to the SerDes receiver failing to properly establish synchronization with the SerDes transmitter; excessive jitter or clock drift that can prevent the CDR circuitry from properly locking onto the incoming signal, resulting in loss of synchronization; failure to deserialize the incoming serial data stream, or the like.

In some more embodiments, the process 900 may transmit a reusable SIGNAL_OK signal to the MAC receiver (block 940). The process 900 may transmit the SIGNAL_OK signal from the SerDes receiver to the MAC receiver. The SIGNAL_OK signal may indicate that the SerDes receiver has lost its synchronization due to the detected failure. This SIGNAL_OK signal may be reused to indicate any failure in the power-down mode of the SerDes receiver, that requires a transition from the power-down mode to the power-up mode and a link re-establishment moving to a link down state.

In yet various embodiments, the process 900 may perform link re-establishment to resolve the failure (block 950). The process 900 may perform the link re-establishment at the SerDes receiver. The process 900 may perform the link re-establishment to restore the communication link between the SerDes transmitter and the SerDes receiver. In yet more embodiments, for link re-establishment, the process 900 may perform signal and clock recovery for re-synchronizing the SerDes receiver with the SerDes transmitter. In still yet more embodiments, in response to determining that no failure is detected, the process 900 may continue to determine whether a failure is detected (block 935).

Furthermore, in many further embodiments, in response to determining that the received data does not correspond to a last valid transaction, the process 900 may transmit the data to the MAC receiver (block 960). The process 900 may transmit the deserialized data or parallel data from the SerDes receiver to the MAC receiver over the parallel data bus. In many additional embodiments, the parallel data is free of one or more idle data patterns. The MAC receiver may process the parallel data, for example, by stripping off the MAC header, checking for errors through the checksum or the CRC), and extracting payload data after verifying the destination MAC address. In still yet further embodiments, the MAC receiver may handle flow control or retransmission requests. The process 900 may then continue to determine whether the received data corresponds to the last valid transaction (block 915).

Although a specific embodiment for a process 900 for dynamically managing power of an Ethernet interface to resolve a device failure suitable for carrying out the various steps, processes, methods, and operations described herein is discussed with respect to FIG. 9 any of a variety of systems and/or processes may be utilized in accordance with embodiments of the disclosure. For example, in still yet additional embodiments, the process 900 may implement Energy Efficient Ethernet (EEE) for link re-establishment. The elements depicted in FIG. 9 may also be interchangeable with other elements of FIGS. 1-8 and FIG. 10 as required to realize a particularly desired embodiment.

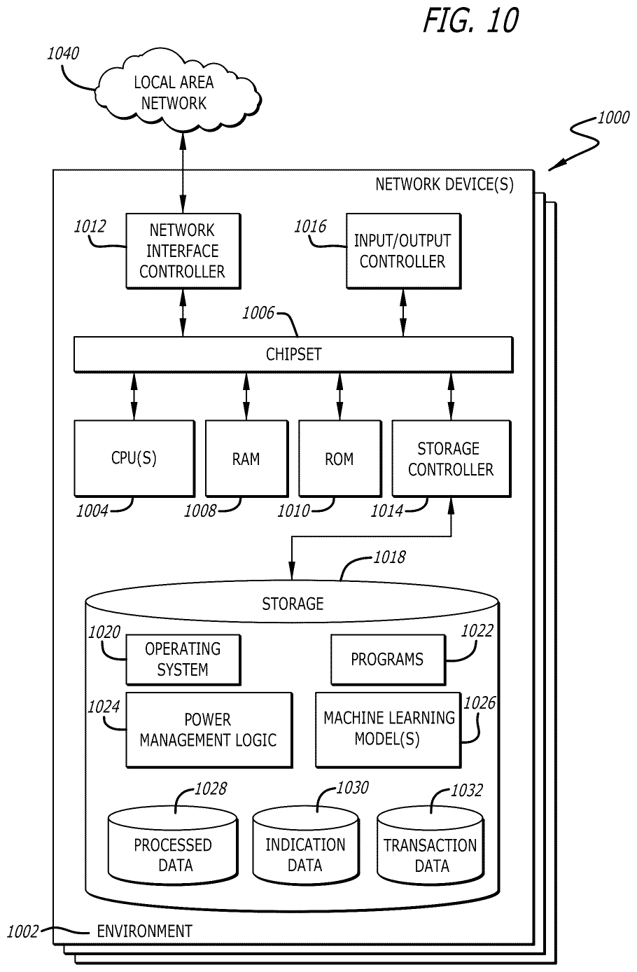

Referring to FIG. 10, a conceptual block diagram of a device 1000 suitable for configuration with the power management logic 1024 for implementing the functionality and various embodiments of the disclosure is shown. The embodiment of the device 1000 in the conceptual block diagram depicted in FIG. 10 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1000 may, in some examples, correspond to a physical device or to a virtual resource described herein. The device 1000 can be a network device, for example, an access point, a router, a switch, any type of edge-based network device, a server, a system, or the like in accordance with various embodiments of the disclosure.

In many embodiments, the device 1000 may include an environment 1002 such as a baseboard or a “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In a number of embodiments, one or more processors 1004, such as, but not limited to, CPUs can be configured to operate in conjunction with a chipset 1006. The processor(s) 1004 can be standard programmable CPUs that perform arithmetic and logical operations necessary for the operation of the device 1000.

In a variety of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a Random-Access Memory (RAM) 1008, which can be utilized as the main memory in the device 1000 in some embodiments. The chipset 1006 can further be configured to provide an interface to a computer-readable storage medium such as a Read-Only Memory (ROM) 1010 or a Non-Volatile RAM (NVRAM) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040 (shown as “LAN 1040”). The chipset 1006 can include functionality for providing network connectivity through a Network Interface Controller (NIC) 1012, which may include a gigabit Ethernet adapter or similar component. The NIC 1012 can be capable of connecting the device 1000 to other devices over the network 1040. It is contemplated that multiple NICs 1012 may be present in the device 1000, connecting the device 1000 to other types of networks and remote systems.

In more embodiments, the device 1000 can be connected to a storage 1018 that provides non-volatile storage for data accessible by the device 1000. The storage 1018 can, for example, store an operating system 1020, applications or programs 1022, processed data 1028, indication data 1030, and transaction data 1032, which are described in greater detail below. The storage 1018 can be connected to the environment 1002 through a storage controller 1014 connected to the chipset 1006. In additional embodiments, the storage 1018 can include one or more physical storage units. The storage controller 1014 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1000 can store data within the storage 1018 by transforming the physical state of the physical storage units to reflect the information being stored. The specific transformation of the physical state can depend on various factors. Examples of such factors can include, but are not limited to, the technology utilized to implement the physical storage units, whether the storage 1018 is characterized as primary or secondary storage, and the like. For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to the device 1000. Stated otherwise, some or all of the operations performed by the cloud computing network, and or any components included therein, may be performed by the device 1000 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1018 can store an operating system 1020 utilized to control the operation of the device 1000. According to one embodiment, the operating system 1020 includes the LINUX operating system. According to another embodiment, the operating system 1020 includes the Windows® server operating system from Microsoft Corporation of Redmond, Washington. According to further embodiments, the operating system 1020 can include the UNIX operating system or one of its variants. It should be appreciated that other operating systems can also be utilized. The storage 1018 can store other system or application programs and data utilized by the device 1000.

In still more embodiments, the storage 1018 or other computer-readable storage media is encoded with computer-executable instructions which, when loaded into the device 1000, may transform the device 1000 from a general-purpose computing system into a special-purpose computer capable of implementing the embodiments described herein. These computer-executable instructions may be stored as applications or programs 1022 and transform the device 1000 by specifying how the processor(s) 1004 can transition between states, as described above. In still further embodiments, the device 1000 has access to computer-readable storage media storing computer-executable instructions which, when executed by the device 1000, perform the various processes described above with regard to FIG. 1-9. In still additional embodiments, the device 1000 can also include computer-readable storage media having instructions stored thereupon for performing any of the other computer-implemented operations described herein.

In some more embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 may not include all of the components shown in FIG. 10, and can include other components that are not explicitly shown in FIG. 10, or may utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In yet various embodiments, the device 1000 can include a power management logic 1024 that may be responsible for dynamic power management of an Ethernet interface. In yet more embodiments, the power management logic 1024 may operate in an automation system. In embodiments where the device 1000 corresponds to a transmitting network device, the power management logic 1024 can be configured to perform various operations such as, but not limited to, determining an absence of pending data for processing; completing transmission of residual processed data of an on-going data transfer operation based on the determined absence of the pending data for the processing; and transmitting one or more control indications to a SerDes transmitter based on the completion of the transmission of the residual processed data, where the SerDes transmitter is configured to transition from the power-up mode to the power-down mode based on the control indication(s). In embodiments where the device 1000 corresponds to a transmitting network device, the power management logic 1024 can be configured to perform various operations such as, but not limited to, determining a presence of the pending data for the processing; and transmitting another one or more control indications to the SerDes transmitter based on the determined presence of the pending data for the processing, where the SerDes transmitter is further configured to transition from the power-down mode to the power-up mode based on the other control indication(s). In still yet more embodiments where the device 1000 corresponds to a receiving network device, the power management logic 1024 can be configured to perform various operations such as, but not limited to, determining that the received data corresponds to one of a last valid transaction or a first valid transaction; and transmitting one or more control indications to the MAC receiver based on the received data corresponding to the one of the last valid transaction or the first valid transaction, wherein, based on the one or more control indications, the MAC receiver is configured to transition from a first power mode to a second power mode.

Those skilled in the art will recognize that the power management logic 1024 can include various hardware and/or software deployments and can be configured in a variety of ways. In many additional embodiments, the power management logic 1024 can be configured as a standalone device, exist as a logic in another network device, be distributed among various network devices operating in tandem, or remotely operated as part of a cloud-based network management tool. In still yet further embodiments, one or more servers can be configured with the power management logic 1024 or can otherwise operate as the power management logic 1024. In still yet additional embodiments, the power management logic 1024 may operate on one or more servers connected to a communication network, for example, the Internet. The communication network can include wired networks or wireless networks. The power management logic 1024 can be provided as a cloud-based service that can service remote networks, such as, but not limited to, a deployed network. Further, in several embodiments, the power management logic 1024 may be operated as a distributed logic across multiple network devices. In an embodiment, the controller can operate as the power management logic 1024 or may have multiple devices operate as the power management logic 1024 in a distributed manner.

In several more embodiments, the storage 1018 can include processed data 1028. The processed data 1028 may relate to data representative of pending data and idle data patterns processed by a multiplexer in a MAC transmitter into a single output data stream. The processed data 1028 may include the data stream processed within a data pipeline in the MAC transmitter and residual processed data contained therein prior to transmission to the SerDes transmitter via a parallel data bus.

In further additional embodiments, the storage 1018 can include indication data 1030. The indication data 1030 may relate to data representative of one or more control indications transmitted to the SerDes transmitter based on the completion of the transmission of the residual processed data. In some more embodiments, the indication data 1030 may include a power-transition signal configured to trigger the transition of the SerDes transmitter from a power-up mode to a power-down mode, a power-transition signal configured to trigger the transition of the SerDes transmitter from the power-down mode to the power-up mode, an indication of a valid transaction configured to trigger the transmission of pending data to the SerDes transmitter, or the like.

In many embodiments, the storage 1018 can include transaction data 1032. The transaction data 1032 may relate to data representative of a first transaction including a first valid bit index associated with the received data, a last transaction including a last bit of the residual processed data, a valid transaction configured to trigger the transmission of the pending data to the SerDes transmitter, or the like.

In a number of embodiments, data may be processed into a format usable by an ML model(s) 1026 (e.g., feature vectors), and/or other pre-processing techniques. The ML model(s) 1026 may be any type of ML model(s), such as supervised models, reinforcement models, and/or unsupervised models. The ML model(s) 1026 may include one or more of linear regression models, logistic regression models, decision trees, Naïve Bayes models, neural networks, k-means cluster models, random forest models, and/or other types of ML models. The ML model(s) may include an LLM, an LAM, or the like. In a variety of embodiments, the ML model(s) 1026 may be configured to analyze the control indications for deriving the indication data 1030. In various embodiments, the ML model(s) 1026 may be configured to analyze the indication data 1030 and the transaction data 1032 to extract relevant control indications and transaction, respectively, for power mode transitions of the SerDes transmitter, the SerDes receiver, and the MAC receiver.

Although a specific embodiment for a device 1000 suitable for configuration with the power management logic 1024 for carrying out the various steps, processes, methods, and operations described herein is discussed with respect to FIG. 10, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the power management logic 1024 acts in tandem between the devices. The elements depicted in FIG. 10 may also be interchangeable with other elements of FIG. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A transmitting network device, comprising:
a Serializer/Deserializer (SerDes) transmitter operable in a power-up mode or a power-down mode;
one or more processors;
a memory communicatively coupled to the one or more processors; and
a power management logic configured to:
determine an absence of pending data for processing;
complete transmission of residual processed data of an ongoing data transfer operation based on the determined absence of the pending data for the processing; and
transmit one or more control indications to the SerDes transmitter based on the completion of the transmission of the residual processed data, wherein
the SerDes transmitter is configured to transition from the power-up mode to the power-down mode based on the one or more control indications.

2. The transmitting network device of claim 1, further comprising a data buffer configured to store the pending data for the processing, wherein the determination of the absence of the pending data is based on the data buffer being empty.

3. The transmitting network device of claim 2, wherein the determination of the absence of the pending data is based on the data buffer being empty for a configured time period.

4. The transmitting network device of claim 2, further comprising a data pipeline, operably coupled to the data buffer, that is configured to provide the residual processed data of the ongoing data transfer operation to the SerDes transmitter for the transmission.

5. The transmitting network device of claim 1, wherein, based on the determined absence of the pending data, the power management logic is further configured to terminate a transmission of one or more idle data patterns to the SerDes transmitter.

6. The transmitting network device of claim 1, wherein at least one control indication of the one or more control indications comprises an indication of a last transaction including a last bit of the residual processed data.

7. The transmitting network device of claim 1, wherein at least one control indication of the one or more control indications comprises a power-transition signal configured to trigger the transition of the SerDes transmitter from the power-up mode to the power-down mode.

8. The transmitting network device of claim 1, wherein
the power management logic is further configured to:
determine a presence of the pending data for the processing; and
transmit another one or more control indications to the SerDes transmitter based on the determined presence of the pending data for the processing, and
the SerDes transmitter is further configured to transition from the power-down mode to the power-up mode based on the another one or more control indications.

9. The transmitting network device of claim 8, wherein at least one control indication of the another one or more control indications comprises a power-transition signal configured to trigger the transition of the SerDes transmitter from the power-down mode to the power-up mode.

10. The transmitting network device of claim 8, wherein, based on the transition of the SerDes transmitter to the power-up mode, the power management logic is further configured to receive feedback from the SerDes transmitter regarding readiness to receive the pending data.

11. The transmitting network device of claim 8, wherein at least one control indication of the another one or more control indications comprises an indication of a valid transaction configured to trigger the transmission of the pending data to the SerDes transmitter.

12. The transmitting network device of claim 11, wherein the SerDes transmitter is further configured to transmit the pending data from a parallel data bus to a serial data line.

13. The transmitting network device of claim 1, further comprising a media access control transmitter configured to provide the residual processed data of the ongoing data transfer operation to the SerDes transmitter for the transmission, wherein the power management logic is configured in the media access control transmitter.

14. A receiving network device, comprising:
a Serializer/Deserializer (SerDes) receiver configured to receive data from a transmitting network device;
a media access control receiver coupled to the SerDes receiver; and
a power management logic configured to:
determine that the received data corresponds to one of a last valid transaction or a first valid transaction; and
transmit one or more control indications to the media access control receiver based on the received data corresponding to the one of the last valid transaction or the first valid transaction, wherein, based on the one or more control indications, the media access control receiver is configured to transition from a first power mode to a second power mode.

15. The receiving network device of claim 14, wherein based on the received data corresponding to the first valid transaction:
the one or more control indications comprises a first valid signal configured to trigger the transition of the media access control receiver,
the first valid signal comprises a first valid bit index associated with the received data, and
the transition from the first power mode to the second power mode comprises a transition from a power-down mode to a power-up mode.

16. The receiving network device of claim 14, wherein based on the received data corresponding to the first valid transaction:
the one or more control indications comprises a power-transition signal configured to trigger the transition of the media access control receiver, and
the transition from the first power mode to the second power mode comprises a transition from a power-down mode to a power-up mode.

17. The receiving network device of claim 14, wherein based on the received data corresponding to the last valid transaction:
the one or more control indications comprises a last valid signal configured to trigger the transition of the media access control receiver,
the last valid signal comprises a last valid bit index associated with the received data, and
the transition from the first power mode to the second power mode comprises a transition from a power-up mode to a power-down mode.

18. The receiving network device of claim 14, wherein based on the received data corresponding to the last valid transaction:
the one or more control indications comprises a power-transition signal configured to trigger the transition of the media access control receiver, and
the transition from the first power mode to the second power mode comprises a transition from a power-up mode to a power-down mode.

19. The receiving network device of claim 14, wherein the received data from the transmitting network device is free of one or more idle data patterns.

20. A method, comprising:
determining absence of pending data for processing;
completing transmission of residual processed data of an ongoing data transfer operation based on the determined absence of the pending data for the processing; and
transmitting one or more control indications to a Serializer/Deserializer (SerDes) transmitter based on the completion of the transmission of the residual processed data, wherein
the SerDes transmitter is configured to transition from a power-up mode to a power-down mode based on the one or more control indications.
